(19) United States
(12) Patent Application Publication
(10) Pub. No.: US 2010/0165460 A1
(43) Pub. Date: Jul. 1, 2010

(54) OPTICAL LAYERED BODY, POLARIZER, AND IMAGE DISPLAY DEVICE

(75) Inventors: Gen Furui, Tokyo (JP); Yukimitsu Iwata, Tokyo (JP); Atsuhiro Kobayashi, Tokyo (JP); Tomoyuki Horio, Tokyo (JP)

Correspondence Address: CONNOLLY BOVE LODGE & HUTZ LLP, 1875 EYE STREET, N.W., SUITE 1100, WASHINGTON, DC, 20006, US

(73) Assignee: DAI NIPPON PRINTING CO, LTD, Tokyo (JP)

(21) Appl. No.: 12/377,713

(22) PCT Filed: Aug. 16, 2007
(86) PCT No.: PCT/JP2007/065967

§ 371 Date: Apr. 17, 2009

(30) Foreign Application Priority Data
Aug. 18, 2006 (JP) 2006-223526

(51) Int. Cl. G02B 5/02; B32B 3/00; B05D 5/06; G02B 5/30; G02B 1/11

(52) U.S. Cl. 359/493; 428/141; 427/164; 359/599; 359/601

(57) ABSTRACT

It is an object of the present invention to provide an optical layered body having sufficient hardness as an optical layered body and exhibiting a good antiglare property.

An optical layered body, comprising a light-transmitting substrate and a hard coat layer formed on the light-transmitting substrate,
wherein the hard coat layer comprises two layers of a clear hard coat layer (A) and a hard coat layer (B),
the hard coat layer (B) has a surface roughness on the outermost surface and satisfies

0.0010≦φ≦0.14

0.25≦θa≦5.0

in the case where Sm is defined as a mean spacing of profile irregularities; θa is defined as a mean inclination angle of profile irregularities; Rz is defined as a mean roughness of the surface roughness; and φ is defined as Rz/Sm, and
the optical layered body has substantially no interface between the clear hard coat layer (A) and the light-transmitting substrate.

### TECHNICAL FIELD

The present invention relates to an optical layered body, a polarizer, and an image display device.

### BACKGROUND ART

With respect to an image display device such as a cathode-ray tube display device (CRT), a liquid crystal display (LCD), a plasma display (PDP), an electroluminescence display (ELD), and the like, an optical layered body using a light-transmitting substrate is generally provided on the outermost surface for preventing reflection. Such an antireflection optical layered body is for suppressing reflection of an image or decreasing the reflectance by light scattering or light interference.

As the above-mentioned antireflection optical layered body, those including a light-transmitting substrate and a hard coat layer formed thereon have been known. Such a hard coat layer is for solving a problem that the light-transmitting substrate tends to detract transparency due to adhesion of dust and adhesion of stains because of static electricity and generation of abrasions and scratches. An optical layered body provided with a desired function (e.g. an antistatic property, an antifouling property, an antireflection property, and the like) on such a hard coat layer has also been known. As one of functions to be given to such a hard coat layer, an antiglare property obtained by making a surface of the hard coat layer rough has been known.

However, if a hard coat layer is formed on a light-transmitting substrate surface in this way, interference fringes are generated by interfering the reflected light of the light-transmitting substrate surface and the reflected light of the hard coat layer surface to result in a problem of detraction of the appearance. Further, in the case where the light-transmitting substrate is made from an amorphous olefin polymer (COP) or the like, since the adhesion property to the hard coat layer is poor, a formation of the hard coat layer on the substrate has been difficult. Further, since the hardness of the COP itself is B or less based on pencil hardness and thus very weak, it has been impossible to obtain sufficient hardness if a merely conventional hard coat layer is formed.

Patent Document 1 discloses an optical film with suppressed generation of interference fringes by forming a plurality of transparent layers and specifying the property of the interfaces. However, it is not described to obtain the antiglare property by providing a surface roughness on the surface.

Patent Document 1: Japanese Kokai Publication 2005-107005

### DISCLOSURE OF THE INVENTION

### Problems to be Solved by the Invention

In view of the above state of the art, it is an object of the present invention to provide an optical layered body having sufficient hardness as an optical layered body and exhibiting a good antiglare property.

### Means for Solving the Problems

The present invention relates to an optical layered body comprising a light-transmitting substrate and a hard coat layer formed on the light-transmitting substrate, wherein the hard coat layer comprises two layers of a clear hard coat layer (A) and a hard coat layer (B), and the hard coat layer (B) has a surface roughness on the outermost surface and satisfies

0.0010≦φ≦0.14

0.25≦θa≦5.0

in the case where Sm is defined as a mean spacing of profile irregularities; θa is defined as a mean inclination angle of profile irregularities; Rz is defined as a mean roughness of the surface roughness; and φ is defined as Rz/Sm, and the optical layered body has substantially no interface between the clear hard coat layer (A) and the light-transmitting substrate.

Preferably, in the above-mentioned an optical layered body, Rz is 0.3 to 5.0 μm; Sm is 40 to 400 μm; and 0.0020≦φ≦0.080.

Preferably, the hard coat layer (B) is formed from a composition (B) containing an urethane (meth)acrylate compound having six or more functional groups.

Preferably, the urethane (meth)acrylate compound has a weight average molecular weight of 1000 to 50000.

Preferably, the above-mentioned optical layered body has substantially no interference fringe.

Preferably, the clear hard coat layer (A) is formed using a compound (A) having a weight average molecular weight of 200 or more and three or more functional groups.

Preferably, the compound (A) is at least one kind compound of (meth)acrylic compounds and/or urethane (meth)acrylic compounds.

Preferably, the above-mentioned optical layered body is an antireflection layered body.

Preferably, the above-mentioned optical layered body has the surface haze value of 0.5 to 30 or lower.

Preferably, the above-mentioned optical layered body has 4H or higher under the condition of 4.9 N load in a pencil hardness test according to JIS K5400.

The present invention also relates to a method for producing the above-mentioned optical layered body, comprising steps for forming a clear hard coat layer (A) by applying a composition for the clear hard coat layer (A) to the surface of a light-transmitting substrate produced from a triacetyl cellulose as a raw material; and forming a hard coat layer (B) by applying a composition for the hard coat layer (B) to the clear hard coat layer (A).

The present invention also relates to a self-luminous image display device comprising the above-mentioned optical layered body on the outermost surface.

The present invention also relates to a polarizer comprising a polarizing element, wherein the surface of the polarizing element has the above-mentioned optical layered body on the face opposite to a face where the hard coat layer of the optical layered body is present.

The present invention also relates to a non-self-luminous image display device comprising the above-mentioned optical layered body or the above-mentioned polarizer on the outermost surface.

Hereinafter, the present invention will be described in detail.

An optical layered body of the present invention can prevent interference fringes since the optical layered body has substantially no interface between a light-transmitting substrate and a clear hard coat layer (A) formed thereon and further can be provided with a good antiglare property since the surface has a surface roughness. Further, the adhesion property between the light-transmitting substrate and the hard coat layer is good and thus the hard coat layer can be formed even on COP or the like, on which it is generally difficult to form a hard coat layer. Therefore, according to the present invention, an optical layered body which prevents the interference fringes and is provided with an excellent antiglare property and sufficient hardness can be obtained.

The optical layered body of the present invention is provided with sufficient hardness by forming a bilayer hard coat layer. The above-mentioned hard coat layer is composed of two layers; a clear hard coat layer (A) and clear hard coat layer (B) and in the optical layered body of the present invention, the optical property is controlled by making a surface roughness of the hard coat layer (B) to be an upper layer in the above range and accordingly a good antiglare property is obtained simultaneously. Herein, the clear hard coat layer means a hard coat layer causing no light scattering in the hard coat layer and on the layer surface and having transparency.

The optical layered body of the present invention has substantially no interface between the above-mentioned clear hard coat layer (A) and the light-transmitting substrate. The above-mentioned “having (substantially) no interface” encompasses 1) although two layer faces are overlapped, there is actually no interface and 2) it is determined that no interface exists in both faces in terms of refractive index.

A specific basis of “having (substantially) no interface” is by interference fringe observation of the optical layered body. That is, a black tap is stuck to the back side of the optical layered body and under radiation by a three-wavelength fluorescent lamp, an observation is carried out visually above the optical layered body. In this case, if interference fringes are observed, an interface is observed in the case where laser microscope observation of a cross section is carried out separately and therefore, “having an interface” is determined. On the other hand, if interference fringes are not observed or extremely slightly observed, since an interface is not observed or extremely thinly observed in the case where laser microscope observation of a cross section is carried out separately and therefore, “having substantially no interface” is determined. That is, the optical layered body of the present invention is desirable to have substantially no interference fringe. Additionally, the laser microscope can read reflected light from respective interfaces and nondestructively observe a cross section. That is because an interface is observed only in the case where there is refractive index difference in each layer, if no interface is observed, it can be supposed that there is no difference of refractive indexes and there is no interface.

With respect to the outer appearance property of the cross section, since the cross sectional phase of the clear hard coat layer (A) has a configuration in which the cross section phase continuously exists from the clear hard coat layer (A) to the light-transmitting substrate, a structure where the clear hard coat layer (A) and the light-transmitting substrate are substantially integrated is efficiently maintained and consequently, the optical layered body of the present invention can suppress interference fringes and further high adhesion property can be exhibited. The hard coat layer (B) is formed on this layered body excellent in the adhesion property and having higher hardness than that of the light-transmitting substrate, so that sufficient hardness can be obtained.

The above-mentioned clear hard coat layer (A) is preferable composed of a binder resin. In this specification, the above-mentioned resin is a concept including resin components such as monomers, oligomers, and the like. The above-mentioned binder resin is not particularly limited if the binder resin has transparency and examples include three kinds of resins; ionizing radiation-curable resins, which are resins to be cured by ultraviolet rays or electron beams, mixtures of the ionizing radiation-curable resins and solvent-drying resins (resins to form coats only by drying solvent added for adjusting the solid matter at the time of coating), and thermosetting resins, and preferred is the ionizing radiation-curable resins. Further, according to a preferable aspect of the present invention, a resin containing at least the ionizing radiation-curable resin and the thermosetting resin may be used.

Examples of the above-mentioned ionizing radiation-curable resin include compounds having one or more unsaturated bonds such as compounds having radical polymerizable functional groups such as (meth)acrylate groups. Examples of compounds having one unsaturated bond may be ethyl (meth)acrylate, ethylhexyl (meth)acrylate, styrene, methylstyrene, N-vinylpyrrolidone, and the like. Examples of compounds having two or more unsaturated bonds may include polyfunctional compounds such as polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, neopentyl glycol di(meth)acrylate, and the like; and reaction products (for example, a poly(meth)acrylate ester of polyhydric alcohol) of the polyfunctional compounds with (meth)acrylate, and the like. Here, in this description, “(meth)acrylate” means methacrylate and acrylate.

In addition to the above-mentioned compounds, a polyester resin, a polyether resin, an acrylic resin, an epoxy resin, a urethane resin, an alkyd resin, a spiroacetal resin, a polybutadiene resin, and a polythiol-polyen resin, which have an unsaturated double bond and a relatively low molecular weight, may also be used as the ionizing radiation-curable resin.

In the case where the ionizing radiation-curable resin is used as an ultraviolet-curable resin, it is preferable to use a photopolymerization initiator. Specific examples of the photopolymerization initiator include acetophenones, benzophenones, Michler's benzoyl benzoate, α-amyloxime ester, thioxanthones, propiophenones, benzils, benzoins, acylphosphine oxides, propiophenones, benzils, acylphosphine oxides, and the like. Further, a photo-sensitizer is preferably used by mixing with a photopolymerization initiator. Specific examples thereof include n-butylamine, triethylamine, poly(n-butylphosphine), and the like.

In the case where the photopolymerization initiator is a resin having a radical polymerizable unsaturated group, acetophenones, benzophenones, thioxanthones, benzoin, benzoin methyl ether and the like are preferably used alone or in form of a mixture. Further, in the case of a resin having a cationic polymerizable functional group, it is preferable to use, as a photopolymerization initiator, aromatic diazonium salts, aromatic sulfonium salts, aromatic iodonium salts, metallocene compounds, benzoinsulfonic acid esters alone or in form of a mixture. The addition amount of a photopolymerization initiator is preferably 0.1 to 10 parts by weight based on 100 parts by weight of an ionizing radiation-curable resin.

The above-mentioned ionizing radiation-curable resin may be used in combination with a solvent-drying resin. Examples of the solvent-drying resin that can be used in combination with the above-mentioned ionizing radiation-curable resin are not particularly limited and in general, a thermoplastic resin can be used. Use of the solvent-drying resin in combination efficiently prevents coating defects of the application surface and accordingly, more excellent gloss blackness can be obtained. The above-mentioned thermoplastic resin is not particularly limited and examples include such as styrene resins, (meth)acrylic resins, vinyl acetate resins, vinyl ether resins, halogen-containing resins, alicyclic olefin resins, polycarbonate resins, polyester resins, polyamide resins, cellulose derivatives, silicone resins, and rubber or elastomers. The above-mentioned thermoplastic resin is preferably amorphous and soluble in an organic solvent (particularly common solvents in which a plurality of polymers and curable compounds are soluble). Particularly, in terms of film formability, transparency, and weathering resistance, such as styrene resins, (meth)acrylic resins, alicyclic olefin resins, polyester resins, cellulose derivatives (cellulose esters, and the like) are preferable.

According to a preferable aspect of the present invention, in the case where a material for the light-transmitting substrate is a cellulose resin such as triacetyl cellulose “TAC” or the like, specifically preferable examples of the thermoplastic resin include cellulose resins such as nitrocellulose, acetyl cellulose, cellulose acetate propionate, ethylhydroxyethyl cellulose and the like. Use of the cellulose resin can improve the adhesion property of the light-transmitting substrate and an antistatic layer (if necessary) and the transparency.

Examples of thermosetting resin that can be used as the above-mentioned binder resin include phenol resins, urea resins, diallyl phthalate resins, melanine resins, guanamine resins, unsaturated polyester resins, polyurethane resins, epoxy resins, aminoalkyd resins, melamine-urea co-condensation resins, silicon resins, polysiloxane resins, and the like. In the case where a thermosetting resin is used, based on the necessity, a curing agent such as a crosslinking agent, a polymerization initiator and the like, a polymerization promoter, a solvent, a viscosity adjustment agent, and the like may be used in combination.

As the above-mentioned binder resin, a compound (A) having a weight average molecular weight of 200 or more and three or more functional groups is preferable to be used. Use of such a compound (A) can efficiently suppress formation of interference fringes.

The above-mentioned weight average molecular weight may be 200 or more, preferably 250 or more, more preferably 300 or more, and even more preferably 350 or more. The upper limit of the above-mentioned weight average molecular weight is not particularly limited; however it may be, for example, about 40000. Further, the number of the functional groups is not particularly limited if it is three or more; however it is preferably 4 or more and more preferably 5 or more. The upper limit of the number of the above-mentioned functional groups is not particularly limited, it may be, for example, about 15.

The above-mentioned compound (A) is not particularly limited and examples may include (meth)acrylic compounds, urethane (meth)acrylic compounds, and the like. The above-mentioned (meth)acrylic compounds and urethane (meth)acrylic compounds are not particularly limited and examples may include polyester (meth)acrylate, urethane acrylate, polyethylene glycol di(meth)acrylate, and the like, having the above-mentioned weight average molecular weight and the number of functional groups. As the above-mentioned compound (A), the above-exemplified compounds may be used alone or two or more of them may be used in combination. As the compound (A), conventionally known or commercialized compounds may be used.

The content (solid matter) of the compound (A) in the above-mentioned clear hard coat layer (A) is not particularly limited; however it may be 50 to 100% by weight. The above-mentioned content is preferably 90 to 100% by weight.

The above-mentioned clear hard coat layer (A) can be obtained by using a solution or a dispersion obtained by dissolving or dispersing the above-mentioned binder resin and if necessary an additive in a solvent as a composition for the clear hard coat layer (A), forming a coat of the composition, and curing the coat.

The above-mentioned solvent may be selected and used in accordance with the kind and solubility of the binder resin and it may be a solvent which can evenly dissolve at least the solid matter (a plurality of polymers and curable resin precursors, a polymerization initiator, and other additives). Examples of such a solvent include ketones (acetone, methyl ethyl ketone, methyl isobutyl ketone, cyclohexanone, etc.), ethers (dioxane, tetrahydrofuran, etc.), aliphatic hydrocarbons (hexane, etc.), alicyclic hydrocarbons (cyclohexane, etc.), aromatic hydrocarbons (toluene, xylene, etc.), halogenated carbons (dichloromethane, dichloroethane, etc.), esters (methyl acetate, ethyl acetate, butyl acetate, etc.), water, alcohols (ethanol, isopropanol, butanol, cyclohexanol, etc.), cellosolves (methylcellosolve, ethylcellosolve, etc.), cellosolve acetates, sulfoxies (dimethyl sulfoxide, etc.), amides (dimethylformalmide, dimethylacetamide, etc.), and may be a mixture solvent thereof.

It is preferably methyl isobutyl ketone, cyclohexanone, isopropyl alcohol (IPA), n-butanol, tert-butanol, diethyl ketone, PGME (propylene glycol monomethyl ether), etc.

As the above-mentioned solvent, it is preferable to use a solvent having permeable property to the substrate. The “permeable property” of the permeable solvent means a concept including the permeable property, swelling property, and wetting property to the light-transmitting substrate. Specific examples of the permeable solvent include ketones such as acetone, methyl ethyl ketone, cyclohexanone, methyl isobutyl ketone, and diacetone alcohol; esters such as methyl formate, methyl acetate, ethyl acetate, butyl acetate, and ethyl lactate; nitrogen-containing compounds such as nitromethane, acetonitrile, N-methylpyrrolidone, and N,N-dimethylformamide; glycols such as methyl glycol, and methyl glycol acetate; ethers such as tetrahydrofurane, 1,4-dioxane, dioxolane, and diisopropyl ether; halogenated hydrocarbons such as methylene chloride, chloroform, and tetrachloroethane; glycol ethers such as methyl cellosolve, ethyl cellosolve, butyl cellosolve, and cellosolve acetate; and others such as dimethyl sulfoxide, propylene carbonate, or include mixtures thereof and preferably include esters and ketones such as methyl acetate, ethyl acetate, butyl acetate, methyl ethyl ketone.

In addition, alcohols such as methanol, ethanol, isopropyl alcohol, butanol, and isobutyl alcohol; aromatic hydrocarbons such as toluene and xylene are also usable while being mixed with the above-mentioned solvent. Use of the above-mentioned permeable solvent can prevent interference fringes due to the interface of the light-transmitting substrate and clear hard coat layer (A) and increase the adhesion property and thus it is preferable.

The solvent in the composition for the clear hard coat layer (A) may be set properly to adjust the solid matter content about 5 to 80% by weight. In the case of using the above-mentioned permeable solvent, it is preferable to use the permeable solvent in a range of 10 to 100% by weight, particularly 50 to 100% by weight, in the entire amount of the solvent.

The above-mentioned additives are not particularly limited, and depending on the purposes to increase the hardness of the clear hard coat layer (A), suppress curing shrinkage, control the refractive index, provide the antiglare property, and the like, besides the above-mentioned resins, a dispersant, a surfactant, an antistatic agent, a silane coupling agent, a thickener, a coloring prevention agent, a coloring agent (pigments, dyes), a defoaming agent, a leveling agent, a flame retardant, an ultraviolet absorbent, a tackifier, a polymerization inhibitor, an antioxidant, a surface improver, and the like may be added.

The above-mentioned clear hard coat layer (A) is preferably formed by applying the above-mentioned composition for the clear hard coat layer (A) to a substrate, drying the composition if necessary, and curing the composition by radiating an active energy beam.

A method for applying the composition for the clear hard coat layer (A) include application methods such as a roll coating method, a Mayer bar (metering coating rod) coating method, gravure coating method, and the like.

The above-mentioned active energy beam radiation may include ultraviolet ray or electron beam irradiation. Specific examples of an ultraviolet ray source include light sources such as a very high pressure mercury lamp, a high pressure mercury lamp, a low pressure mercury lamp, a carbon arc lamp, a black light fluorescent lamp, a metal halide lamp, and the like. The wavelength of the ultraviolet rays to be used may be in a wavelength range of 190 to 380 nm. Specific examples of an electron beam source include various types of electron beam accelerators of such as Cockcroft-Walton type, Bandegraft type, resonance transformer type, insulated core transformer type, linear type, Dynamitron type, high frequency type or high frequency type.

A preparation method of the composition for the above-mentioned clear hard coat layer (A) is sufficient if the method mix components evenly and may be carried out according to a conventional method. For example, a conventionally known apparatus such as a paint shaker, a bead mill, a kneader, a mixer, and the like may be used.

The optical layered body of the present invention further includes a hard coat layer (B). The hard coat layer (B) is a layer formed on the outermost surface of the optical layered body and has a surface roughness. In the surface shape of the above-mentioned hard coat layer (B), characteristic of an antiglare property, scintillation prevention, and black color reproducibility such as gloss blackness and the like are simultaneously obtained by adjusting φ and θa within the above-mentioned ranges. Particularly, as the surface roughness excellent in the antiglare property, φ satisfies more preferably 0.0020≦φ≦0.080 and θa satisfies more preferably 0.3≦θa≦2.2.

Further, with respect to the surface roughness of the above-mentioned hard coat layer (B), the ten-point mean roughness (Rz) is preferably in a range of 0.3 to 5.0 μm and the mean spacing of profile irregularities Sm (μm) is preferably 40 to 400 μm. Adjustment of the Rz and Sm in the above-mentioned ranges gives further a good antiglare property, scintillation prevention, and black color reproducibility and therefore, it is preferable.

The outermost surface of the optical layered body of the present invention has a surface roughness. Here, Sm, θa, and Rz in the present description are values obtained by the following methods. Rz (μm) expresses ten-point mean roughness: Sm (μm) expresses the mean spacing of profile irregularities: and θa (degree) expresses a mean inclination angle of profile irregularities. These definitions are based on JIS B 0601-1994 and also described in instructions manual (revised on 1995, 07, 20) of a surface roughness measurement apparatus (Model number: SE-3400, manufactured by Kosaka Laboratory Ltd.). θa (degree) is an angle unit and in the case where the inclination is defined as the vertical and transverse ratio Δa, it is determined by θa (degree)=1/tan Δa=1/(total of the distance of the bottom of local valley of profile and top of local peak of profile of irregularities (equivalent to the height of local peak of profile)/reference length). Herein, “reference length” is the same as the following measurement condition.

In the case where the parameters (Sm, θa, and Rz) expressing the surface roughness of the optical layered body of the present invention are measured, the measurement can be carried out in the following measurement condition by, for example, using the above-mentioned surface roughness measurement apparatus and this measurement is preferable in the present invention.

1) Sensing pin of surface roughness detection part:
Model number/SE2555N (2μ standard) manufactured by Kosaka Laboratory Ltd.
(Curvature radius of tip end 2 μm/apex: 90 degree/material: diamond)
2) Measurement condition of surface roughness measurement apparatus
Reference length (cut-off value λc of roughness curve): 0.8 mm
Evaluation length (reference length (cut-off value λc)×5): 4.0 mm
Feeding speed of the sensing pin: 0.1 mm/s

The ratio φ of the mean roughness (Rz) of the surface roughness and the mean spacing of profile irregularities (Sm) is defined as φ≅Rz/Sm and the ratio of the mean roughness (Rz) of the surface roughness and the mean spacing of profile irregularities (Sm) can be used as an index showing the inclination of profile irregularities. The ratio φ of the mean roughness (Rz) of the surface roughness and the mean spacing of profile irregularities (Sm) is defined as φ≅Rz/Sm and the ratio of the mean roughness (Rz) of the surface roughness and the mean spacing of profile irregularities (Sm) can be used as an index showing the inclination angle of profile irregularities.

Here, these numeral values can be adjusted within properly desired ranges by adjusting the type of the resin to be used for forming the hard coat layer (B), the particle diameter and addition amount of particles to be used for forming peaks and valleys, and film thickness and the like. A formation method of the surface roughness is not particularly limited and a conventionally known method can be employed.

The above-mentioned hard coat layer (B) is preferably composed of an urethane (meth)acrylic compound having six or more functional groups. As the above-mentioned urethane (meth)acrylic compound, at least one kind urethane (meth)acrylic compound having a weight average molecular weight of 1000 to 50000 (preferably 1500 to 40000) can be used preferably. The above-mentioned urethane (meth)acrylic compound is not particularly limited and examples, as commercialized products, may include BS 371 (deca- or higher-functional, molecular weight about 40000) manufactured by Arakawa Chemical Industries, Ltd., HDP (deca-functional, molecular weight 4500) manufactured by Negami Chemical Industrial Co., Ltd., SHIKOH UV 1700 B (deca-functional, molecular weight 2000) manufactured by Nippon Synthetic Chemical Industry Co., Ltd., and the like.

Further, in addition to the above-mentioned urethane (meth)acrylic compound in the present invention, a (meth)acrylic compound having three or more and six or less functional groups (except the above-mentioned urethane (meth)acrylic compounds) may be used in combination. The above-mentioned (meth)acrylic compound is not particularly limited and for example, at least one kind of compounds such as dipentaerythritol hexa(meth)acrylate, pentaerythritol tri(meth)acrylate, and the like is preferably usable.

The content proportion (solid matter) of the sum of the (meth) acrylic compound and the urethane (meth) acrylic compound in the hard coat layer (B) is not particularly limited; however, for example, it is preferably 10 to 100% by weight and more preferably 20 to 100% by weight. As a component other than these compounds, besides the following additives, a compound having less than three functional groups may be contained.

The proportion of the (meth)acrylic compound and the urethane (meth)acrylic compound in the hard coat layer (B) is not particularly limited; however, it is desirable to adjust the (meth)acrylic compound in an amount of 0 to 90% by weight (particularly, 5 to 90% by weight) and the urethane (meth)acrylic compound in an amount of 100 to 10% by weight (particularly, 95 to 10% by weight) in 100% by weight of the sum of the (meth)acrylic compound and the urethane (meth)acrylic compound.

A formation method of the above-mentioned hard coat layer (B) is not particularly limited and for example, a method (a method 1) for forming the hard coat layer (B) having a surface roughness by using a composition for the hard coat layer (B) containing a resin and fine particles; a method (a method 2) for forming the hard coat layer (B) having a surface roughness by using a composition for the hard coat layer (B) containing only a resin or the like without adding fine particles; a method (a method 3) for forming the hard coat layer (B) by carrying out embossing treatment for the surface roughness by using any shaped material; and the like. Hereinafter, these respective methods 1 to 3 will be specifically described.

### (Method 1) A Method for Forming the Hard Coat Layer (B) Having a Surface Roughness by Using a Composition for the Hard Coat Layer (B) Containing a Resin and Fine Particles

The fine particles to be used in the above-mentioned method 1 may be spherical, e.g. truly spherical, elliptical, and the like and preferably truly spherical. Further, some types of fine particles may also be used simultaneously. The average particle diameter (μm) of each type of the fine particles is preferably 1.0 μm or more and 20 μm or less and those having 15.0 μm as the upper limit and 3.5 μm as the lower limit are more preferable. Here, the average particle diameter of the fine particles is a value measured by a laser beam diffraction method and a Coulter method (an electric resistance method). Further, the above-mentioned fine particles may be agglomerated particles and in the case of the agglomerated particles, the particle diameter of the secondary particle is preferably in the above-mentioned range.

It is preferable that 80% or more of the above-mentioned fine particles (preferably 90% or more) are within an average particle diameter±1.0 (preferably 0.3) μm with respect to everyone type of various types of particles. Accordingly, the uniformity of the surface roughness of the obtained optical layered body can be made good.

The above-mentioned fine particles are not particularly limited and inorganic and organic fine particles are usable and transparent particles are preferable. Specific examples of the fine particles formed by using an organic material include plastic beads. Examples of the plastic beads include styrene beads (refractive index 1.60), melamine beads (refractive index 1.57), acryl beads (refractive index 1.49 to 1.53), acryl-styrene beads (refractive index 1.54 to 1.58), benzoguanamine-formaldehyde beads, polycarbonate beads, polyethylene beads and the like. The above-mentioned plastic beads preferably have hydrophobic groups on their surfaces and for example, styrene beads can be exemplified. Examples of the inorganic fine particles can include nonspherical silica or the like.

The above-mentioned nonspherical silica to be used is preferably silica bead with good dispersibility and having a particle diameter of 0.5 to 5 μm. The content of the above-mentioned nonspherical silica is preferably 1 to 30 parts by weight based on the binder resin. To give good dispersibility to the nonspherical silica without increasing the viscosity of the composition for the hard coat layer (B) described below in detail, the average particle diameter and addition amount are changed and at the same time, presence or absence of organic material treatment for the particle surfaces may also be changed to be used. In the case of carrying out the organic material treatment for the particle surfaces, hydrophobic treatment is preferable.

The above-mentioned organic material treatment may be a method for chemically boning a compound to the surfaces of the beads and a physical method for impregnating voids of the composition for forming beads with the material without chemical bonds to the surfaces of the beads and both may be employed. In general, a chemical treatment method using active groups of silica surface such as hydroxyl groups or silanol groups is preferably employed in terms of the treatment efficiency. The compounds to be used for the treatment may be silane, siloxane, and silazane materials having high reactivity with the above-mentioned active groups. Examples include straight chain alkyl monosubstituted silicone materials such as methyltrichlorosilane, branched alkyl monosubstituted silicone materials, or polysubstituted straight chain alkylsilicone compounds such as di-n-butyldichlorosilane, ethyldimethylchlorosilane, and the like and polysubstituted branched chain alkyl silicone compounds. Similarly, straight chain alkyl group or branched alkyl group monosubstituted or polysubstituted siloxane materials and silazane materials can also be effectively used.

In accordance with necessary functions, those having hetero atoms, unsaturated bond groups, cyclic bond groups, aromatic functional groups or the like at the terminal or intermediate position of the alkyl chains may be used. In these compounds, since the alkyl group contained therein is hydrophobic, it is made easy to convert the surface of an object material to be treated to hydrophobic from hydrophilic and high affinity with even a polymer material with poor affinity if the polymer material is no treated can be obtained.

In addition to the above-mentioned fine particles, further a plurality of types of fine particles such as second fine particles and third fine particles with a different average particle diameter may also be contained. Further, the fine particles contain more preferably first fine particles having the above-mentioned particle diameter and second fine particles having an average particle diameter different from that of the first fine particles. In addition, the above-mentioned second fine particles and third fine particles may be fine particles composed of components different from that of the first fine particles.

In the present invention, in the case where the respective fine particles are fine particles composed of different components, if the average particle diameter of the first fine particles is defined as R (μm) and the average particle diameter of the second fine particles is defined as r (μm), the particles satisfying the following expression (I):

0.25R(preferably 0.50)≦r≦1.0R(preferably 0.75) (I)

are preferable.

If r is 0.25R or more, dispersion of the applying solution becomes easy and particles are not agglomerated. Further, in a drying step after application, a uniform surface roughness can be formed without being affected with wind at the time of floating. In the case where the average particle diameter of the third fine particles is defined as r′ (μm), with respect to also the second fine particles r and the third fine particles r′, the relation same as described above is preferable (0.25r (preferably 0.50r) r′ 1.0r(preferably 0.75r)). In the case where the first, second and third fine particles are composed of the same component, it is preferable that the particle diameters differ inevitably.

Further, according to another aspect of the present invention, in the case where the total weight per unit surface area of the (first) fine particles is defined as M₁, the total weight per unit surface area of the second fine particles is defined as M₂, and the total weight per unit surface area of the resin is defined as M, total weight ratio per unit surface area of the resin, (first) fine particles and second fine particles preferably satisfies the following expressions (II) and (III):

0.08≦(M₁+M₂)/M≦0.36 (II)

and

0≦M₂≦4.0M₁ (III).

The above-mentioned second and third fine particles are not particularly limited and inorganic and organic particles similar to those of the first fine particles can be used. The content of the second fine particles is preferably 3 to 100% by weight based on the content of the first fine particles. The third fine particles may be in a similar compounding amount to that of the second fine particles.

The above-mentioned hard coat layer (B) can be formed using a composition for the hard coat layer (B) containing the above-mentioned fine particles and a curable resin. The curable resins are preferably those having transparency and the resins exemplified as the binder resin for the clear hard coat layer (A) can be used.

The above-mentioned hard coat layer (B) can be formed by applying a composition for the hard coat layer (B) obtained by mixing the fine particles and resin to a proper solvent, for example, alcohols such as isopropyl alcohol, methanol and ethanol; ketones such as methyl ethyl ketone (MEK), methyl isobutyl ketone (MIBK) and cyclohexanone; esters such as methyl acetate, ethyl acetate and butyl acetate; halogenated hydrocarbons; aromatic hydrocarbons such as toluene and xylene; propylene glycol monomethyl ether (PGME), or a mixture thereof to the clear hard coat layer (A). The solvent in the composition for the hard coat layer (B) may be properly set to have a solid matter content of about 5 to 80% by weight.

According to a preferable aspect of the present invention, a fluorine or silicone leveling agent is preferably added to the composition for the hard coat layer (B). The composition for the hard coat layer (B) containing the leveling agent can improve the coating applicability and impart an effect of scratching resistance. The leveling agent is preferably utilized for a film-shaped light-transmitting substrate (e.g. triacetyl cellulose and poly(ethylene terephthalate)) required to have heat resistance.

A method for applying the composition for the hard coat layer (B) to the light-transmitting substrate may include application methods of a roll coating method, a Mayer bar (metering coating rod) coating method, a gravure coating method, and the like. Based on the necessity, drying and ultraviolet ray curing are carried out after the application of the composition for the hard coat layer (B). Specific examples of an ultraviolet ray source or an electron beams source can include those described for the above clear hard coat layer (A).

(Method 2) Method for Forming Hard Coat Layer (B) Having Surface Roughness Using Composition for Hard Coat Layer (B) Containing Only Polymer or the Like without Adding Fine Particles

The above-mentioned method is a method for forming a hard coat layer (B) by applying the composition for hard coat layer (B), which is obtained by combining at least two kinds of components selected from the group consisting of polymers and curable resin precursors, and mixing them with a proper solvent, on the clear hard coat layer (A).

According to the method 2, the surface roughness can be formed by using the composition for hard coat layer (B) containing at least two kinds of components selected from the group consisting of polymers and curable resin precursors (hereinafter, the composition is referred to as “composition for phase separation type hard coat layer (B)”). In such a method, use of the composition for phase separation type hard coat layer (B) obtained by mixing at least two kinds of components selected from the group consisting of polymers and curable resin precursors with a proper solvent makes it possible to form a coat having a phase separation structure by Spinodal decomposition from a liquid phase.

The above-mentioned composition for phase separation type hard coat layer (B) can form a phase separation structure with relatively regular inter-phase intervals by causing phase separation by Spinodal decomposition between at least two kinds of components selected from the group consisting of polymers and curable resin precursors during the step for evaporating or removing the solvent by drying or the like after application on the clear hard coat layer (A).

The above-mentioned Spinodal decomposition forms a co-continuous phase structure along with the proceeding of the phase separation generated by removing a solvent and when the phase separation is further promoted, the continuous phase becomes discontinuous due to self surface tension to have a droplet phase structure (e.g. a sea-island structure of spherical, true spherical disk-like, or elliptical independent phases). Accordingly, based on the extent of the phase separation, an intermediate structure between the co-continuous phase structure and droplet phase structure (the phase structure during the process of transferring from the above-mentioned co-continuous phase structure to the droplet phase structure) can also be formed. In the above-mentioned method 2, owing to such Spinodal decomposition, the sea-island structure (droplet phase structure or phase structure in which one phase is independent or isolated), the co-continuous phase structure (or mesh structure), or the intermediate structure in which the co-continuous phase structure and the droplet phase structure are mixed form the fine surface roughness on the surface of the hard coat layer (B) after drying out of the solvent.

Such Spinodal decomposition accompanied with evaporation of the solvent is preferable in that since the average intervals among domains of the phase separation structure have regularity or periodicity and therefore the surface roughness formed finally is provided with regularity or periodicity. The phase separation structure formed by the Spinodal decomposition can be fixed by curing the curable functional groups or curable resin precursors in the polymer. The curable functional groups or curable resin precursors can be cured by heating, light irradiation or combinations of these methods in accordance with the type of the curable resin precursors. The heating temperature is not particularly limited as long as it is a condition of maintaining the phase separation structure formed by the above-mentioned Spinodal decomposition and it is preferably, for example 50 to 150° C. The curing by light irradiation can be carried out in the same manner as that of the clear hard coat layer (A). In the composition for phase separation type hard coat layer (B) having photo-curability, a photopolymerization initiator is preferably contained. The components having curability may be polymers having curable functional groups or curable resin precursors.

At least two kind components selected from the group consisting of the polymers and curable resin precursors are preferably used by selecting the combinations causing phase separation by the Spinodal decomposition in liquid phase. The combination for causing phase separation include, for example, (a) combinations for causing phase separation due to non-compatible with a plurality of polymers with respect to one another; (b) combinations for causing phase separation due to non-compatible with polymers and curable resin precursors; and (c) combinations for causing phase separation due to non-compatible with a plurality of curable resin precursors with respect to one another. Among these combinations, (a) combinations of a plurality of polymers and (b) combinations of polymers and curable resin precursors are preferable and particularly (a) combinations of a plurality of polymers are preferable.

In the phase separation structure, in terms of forming the surface of the hard coat layer (B) with surface roughness and increase of surface hardness, the droplet phase structure having at least island-like domains is advantageous. Here, in the case where a phase separation structure constituted with the polymer and the curable resin precursor has the sea-island structure, the polymer component may form the sea-phase; however the polymer component preferably forms the island-like domains in terms of the surface hardness. Owing to formation of the island-like domains, the surface roughness exhibiting desired optical properties can be formed on the surface of the hard coat layer (B) after drying.

The average intervals of the domains of the above-mentioned phase separation structure practically have, in general, regularity or periodicity and correspond to the surface roughness Sm. The average interphase intervals of the domains may be, for example 40 to 400 μm and preferably about 60 to 200 μm. The average intervals among domains of the above-mentioned phase separation structure can be adjusted by selecting the combinations of resins (particularly selection of resins based on the solubility parameter). Adjustment of the average intervals among domains in such a manner gives a desired value of the intervals of peaks and valleys on the surface of the film to be obtained finally.

Examples of the above-mentioned polymers include cellulose derivatives (e.g. cellulose esters, cellulose carbamates, cellulose ethers), styrene resins, (meth)acrylic resins, organic acid vinyl ester resins, vinyl ether resins, halogen-containing resins, olefin resins (alicyclic olefin resins), polyester resins, polyamide resins, polycarbonate resins, thermoplastic polyurethane resins, polysulfone resins (e.g. polyether sulfone, polysulfone), polyphenylene ether resins (e.g. polymers of 2,6-xylenol), silicone resins (e.g. polydimethylsiloxane, polymethylphenylsiloxane), rubber or elastomers (e.g. diene type rubber such as polybutadiene, polyisoprene, styrene-butadiene copolymers, acrylonitrile-butadiene copolymers, acrylic rubber, urethane rubber, silicone rubber) and the like and they may be used alone or in combination of two or more kinds. At least one polymer among a plurality of polymers may have functional groups involved in the curing reaction of the curable resin precursors, for example, polymerizable groups such as (meth)acryloyl groups. The polymer component may be thermosetting or thermoplastic and a thermoplastic resin is more preferable.

The above-mentioned polymer is preferably amorphous and soluble in an organic solvent (particularly, a common solvent in which a plurality of polymers and curable compounds can be dissolved). Particularly, resins having high moldability, film formability, transparency, and weathering resistance, e.g. styrene resins, (meth)acrylic resins, alicyclic olefin resins, polyester resins, cellulose derivatives (cellulose esters, and the like), are preferable.

Specific examples of the cellulose esters among the above-mentioned cellulose derivatives include aliphatic organic acid esters; cellulose acetates such as cellulose diacetate and cellulose triacetate; C₁₋₆ organic acid esters such as cellulose propionate, cellulose butyrate, cellulose acetate propionate and cellulose acetate butyrate; aromatic organic acid esters, e.g. C₇₋₁₂ aromatic carboxylic acid esters such as cellulose phthalate and cellulose benzoate; inorganic acid esters such as cellulose phosphate and cellulose sulfate; mixed acid esters such as acetic acid/nitric acid cellulose ester; cellulose carbamates such as cellulose phenylcarbamate; cellulose ethers such as cyanoethyl cellulose; hydroxy-C₂₋₄ alkyl cellulose such as hydroxyethyl cellulose and hydroxypropyl cellulose; C₁₋₆ alkyl cellulose such as methyl cellulose and ethyl cellulose; carboxymethyl cellulose or a salt thereof, benzyl cellulose, acetyl alkyl cellulose and the like.

Examples of the above-mentioned styrene resin include homo or copolymers of styrene monomer (e.g. polystyrene, a styrene-α-methylstyrene copolymer, a styrene-vinyltoluene copolymer), and copolymers of styrene monomer and other polymerizable monomers (e.g. (meth)acrylic monomers, maleic anhydride, maleimide monomers, dienes) and the like. Examples of styrene copolymers include a styrene-acrylonitrile copolymer (AS resin), copolymers of styrene and (meth)acrylic monomers (e.g. a styrene-methyl methacrylate copolymer, a styrene-methyl methacrylate-(meth)acrylic acid copolymer), a styrene-maleic anhydride copolymer, and the like. Preferable examples of the styrene resin include polystyrene, copolymers of styrene and (meth) acrylic monomers (e.g. copolymers composed of styrene and methyl methacrylate as main components, such as styrene-methyl methacrylate copolymer), AS resin, styrene-butadiene copolymer, and the like.

As the above-mentioned (meth)acrylic resins, homo or copolymers of (meth)acryl monomers, copolymers of copolymerizable monomers with (meth)acryl monomers and the like can be used. Specific examples of (meth)acrylic monomers include (meth)acrylic acid, C₁₋₁₀ alkyl (meth)acrylate such as methyl (meth)acrylate, ethyl (meth)acrylate, butyl (meth)acrylate, tert-butyl (meth)acrylate, isobutyl (meth)acrylate, hexyl (meth)acrylate, octyl (meth)acrylate, and 2-ethylhexyl (meth)acrylate; aryl (meth)acrylate such as phenyl (meth)acrylate; hydroxyalkyl (meth)acrylate such as hydroxyethyl (meth)acrylate, and hydroxypropyl (meth)acrylate; glycidyl (meth)acrylate; N,N-dialkylaminoalkyl (meth)acrylate; (meth)acrylonitrile; (meth)acrylate having an alicyclic hydrocarbon group such as tricyclodecane, and the like. Specific examples of the copolymerizable monomers include the above-mentioned styrene monomers, vinyl ester monomers, maleic anhydride, maleic acid, fumaric acid and the like, and these monomers may be used alone or in combination of two or more kinds.

Examples of the above-mentioned (meth)acrylic resins include poly(meth)acrylic acid esters such as poly(methyl (meth)acrylate), methyl methacrylate-(meth)acrylic acid copolymers, methyl methacrylate-(meth)acrylic acid ester copolymers, methyl methacrylate-acrylic acid-(meth)acrylic acid copolymers, and (meth)acrylic acid ester-styrene copolymers (MS resin and the like) and the like. Specific examples of preferable (meth)acrylic resins include poly(C₁₋₆ alkyl (meth)acrylate) such as poly(methyl (meth)acrylate), particularly methyl methacrylate resins containing methyl methacrylate (50 to 100% by weight, preferably 70 to 100% by weight) as a main component.

Specific examples of the above-mentioned organic acid vinyl ester resins include homo or copolymers of vinyl ester monomers (poly(vinyl acetate), poly(vinyl propionate), and the like), copolymers of vinyl ester monomers and copolymerizable monomers (ethylene-vinyl acetate copolymer, vinyl acetate-vinyl chloride copolymer, vinyl acetate-(meth)acrylic acid ester copolymer, and the like) and derivatives thereof. Specific examples of the vinyl ester resin derivatives may include polyvinyl alcohol, an ethylene-vinyl alcohol copolymer, a polyvinyl acetal resin, and the like.

Specific examples of the above-mentioned vinyl ether resins include homo or copolymers of vinyl C₁₋₁₀ alkyl ethers such as vinyl methyl ether, vinyl ethyl ether, vinyl propyl ether, and vinyl tert-butyl ether; and copolymers of vinyl C₁₋₁₀ alkyl ethers and copolymerizable monomers (vinyl alkyl ether-maleic anhydride copolymer and the like) and the like.

Specific examples of the above-mentioned halogen-containing resins include poly(vinyl chloride), poly(vinylidene fluoride), vinyl chloride-vinyl acetate copolymer, vinyl chloride-(meth)acrylic acid ester copolymer, vinylidene chloride-(meth)acrylic acid ester copolymer, and the like.

Examples of the above-mentioned olefin resins include homopolymers of olefins such as polyethylene and polypropylene; and copolymers such as an ethylene-vinyl acetate copolymer, an ethylene-vinyl alcohol copolymer, an ethylene-(meth)acrylic acid copolymer, and an ethylene-(meth)acrylic acid ester copolymer. Specific examples of the alicyclic olefin resins include homo or copolymers (e.g. polymers having sterically rigid alicyclic hydrocarbon groups such as tricyclodecane) of cyclic olefins (e.g. norbornene, dicyclopentadiene), copolymers of the above-mentioned cyclic olefin and copolymerizable monomers (e.g. ethylene-norbornene copolymer, propylene-norbornene copolymer). Specific examples of the alicyclic olefin resins are commercially available under the trade names such as “ARTON” and “ZEONEX”.

Examples of the above-mentioned polyester resins include aromatic polyesters using aromatic dicarboxylic acids such as terephthalic acid, homopolyesters such as poly(C₂₋₄ alkylene telephtalate) of polyethylene terephthalate and polybutylene terephthalate, and poly(C₂₋₄ alkylene naphthalate), copolyesters containing C₂₋₄ alkylene arylate units (C₂₋₄ alkylene terephthalate and/or C₂₋₄ alkylene naphthalate) as a main component (e.g. 50% by weight or more) and the like. Specific examples of copolyesters include copolyesters obtained by partially substituting C₂₋₄ alkylene glycols among constituent monomers of the poly(C₂₋₄ alkylene arylate) with polyoxy C₂₋₄ alkylene glycol, C₆₋₁₀ alkylene glycol, alicyclic diol (e.g. cyclohexanedimethanol, hydrogenated bisphenol A, and the like), diols having aromatic rings (9,9-bis(4-(2-hydroxyethoxy)phenyl)fluorene having fluorenone side chains, bisphenol A, bisphenol A-alkylene oxide adduct, and the like) and copolyesters obtained by partially substituting aromatic dicarboxylic acid with asymmetric aromatic dicarboxylic acid such as phthalic acid and isophthalic acid and aliphatic C₆₋₁₂ dicarboxylic acid such as adipic acid. Specific examples of the polyester resins include polyarylate resins, aliphatic polyesters using aliphatic dicarboxylic acids such as adipic acid, and also homo or copolymers of lactones such as 8-caprolactone. Preferable polyester resins are, in general, amorphous like amorphous copolyesters (e.g. C₂₋₄ alkylene arylate copolyesters) and the like.

Examples of the above-mentioned polyamide resins include aliphatic polyamides such as nylon 46, nylon 6, nylon 66, nylon 610, nylon 612, nylon 11, and nylon 12, polyamides obtained from dicarboxylic acids (e.g. terephthalic acid, isophthalic acid, adipic acid, and the like) and diamines (e.g. hexamethylenediamine, meta-xylylenediamine) and the like. Specific examples of the polyamide resins may be homo or copolymers of lactams such as ∈-caprolactam and copolyamides as well without limit to homopolyamides.

Examples of the above-mentioned polycarbonate resins include aromatic polycarbonates containing basically bisphenols (bisphenol A or the like), aliphatic polycarbonates such as diethylene glycol bisallyl carbonate and the like.

As the polymer, polymers having curable functional groups may also be used. The above-mentioned curable functional groups may exist in the polymer main chains or in the side chains and preferably exist in the side chains. Examples of the curable functional groups include condensable groups, reactive groups (e.g. hydroxyl groups, acid anhydride groups, carboxyl groups, amino groups or imino groups, epoxy groups, glycidyl groups, and isocyanato groups), and polymerizable groups (e.g. C₂₋₆ alkenyl groups such as vinyl, propenyl, isopropenyl groups, butenyl, allyl and the like; C₂₋₆ alkynyl groups such as ethynyl, propynyl, butynyl, and the like; and C₂₋₆ alkenylidene groups such as vinylidene), groups having these polymerizable groups (e.g. (meth)acrylolyl group) and the like. Among these functional groups, polymerizable groups are preferable.

A method for introducing the above-mentioned curable functional groups into side chains may include a method for carrying out reaction of a thermoplastic resin having functional groups such as reactive groups and condensable groups with polymerizable compounds having groups reactive with the above-mentioned functional groups and the like.

Examples of the thermoplastic resin having functional groups such as the reactive groups and condensable groups include thermoplastic resins having carboxyl groups or its acid anhydride groups (e.g. (meth)acrylic resins, polyester resins, and polyamide resins); hydroxyl-containing thermoplastic resins (e.g. hydroxyl-containing (meth)acrylic resins, polyurethane resins, cellulose derivatives, polyamide resins), amino group-containing thermoplastic resins (e.g. polyamide resins), and epoxy group-containing thermoplastic resins (e.g. epoxy group-containing (meth)acrylic resins and polyester resins) and the like. Further, resins obtained by introducing the above-mentioned functional groups by copolymerization or graft polymerization into thermoplastic resins such as styrene resins, olefin resins, and alicyclic olefin resins may be used.

As the above-mentioned polymerizable compounds, such as polymerizable compounds having epoxy groups, hydroxyl groups, amino groups, or isocyanato groups may be used in the case of reaction with thermoplastic resins having carboxyl groups or its anhydride groups. In the case of reaction with hydroxyl group-containing thermoplastic resins, examples include such as polymerizable compounds having carboxyl groups, its acid anhydride groups, isocyanato groups, and the like. In the case of reaction with amino group-containing thermoplastic resins, examples include such as polymerizable compounds having carboxyl groups, its acid anhydride groups, epoxy groups, isocyanato groups and the like. In the case of reaction with epoxy group-containing thermoplastic resins, examples include such as polymerizable compounds having carboxyl groups, its acid anhydride groups, amino groups and the like.

Among the above-mentioned polymerizable compounds, examples of the epoxy group-containing polymerizable compounds include epoxycyclo C₅₋₈ alkenyl (meth)acrylate such as epoxycyclohexenyl (meth)acrylate, glycidyl (meth)acrylate, allyl glycidyl ether, and the like. Examples of the hydroxyl group-containing compounds include hydroxy C₁₋₄ alkyl (meth)acrylate such as hydroxypropyl (meth)acrylate, C₂₋₆ alkylene glycol (meth)acrylate such as ethylene glycol mono(meth)acrylate, and the like. Examples of amino group-containing polymerizable compounds include amino C₁₋₄ alkyl (meth)acrylate such as aminoethyl (meth)acrylate, C₃₋₆ alkenylamine such as allylamine, aminostyrenes such as 4-aminostyrene and diaminostyrene and the like. Examples of the isocyanato group-containing polymerizable compounds include (poly)urethane (meth)acrylate, vinyl isocyanate and the like. Examples of carboxyl group or its acid anhydride group-containing polymerizable compounds include unsaturated carboxylic acids such as (meth)acrylic acid, maleic anhydride, anhydrides thereof or the like.

As representative examples, combinations of carboxyl group or its acid anhydride group-containing thermoplastic resins with epoxy-containing compounds; particularly (meth)acrylic resins (e.g. (meth)acrylic acid-(meth)acrylic acid ester copolymers) with epoxy group-containing (meth)acrylate (epoxycycloalkenyl (meth)acrylate and glycidyl (meth)acrylate) are included.

Specific examples include polymers obtained by introducing polymerizable unsaturated groups into some of carboxyl groups of (meth)acrylic resins, e.g. (meth)acrylic polymers (Cyclomer P, manufactured by Daicel Chemical Industries Ltd.) obtained by introducing photopolymerizable unsaturated groups in side chains by reaction of an epoxy group of 3,4-epoxycyclohexenylmethyl acrylate with some of carboxyl groups of (meth)acrylic acid-(meth)acrylic acid ester copolymers, or the like can be used.

The introduction amount of the functional groups (particularly polymerizable groups) relevant to curing reaction with the thermoplastic resins is preferably 0.001 to 10 mol, more preferably 0.01 to 5 mol and even more preferably about 0.02 to 3 mol based on 1 kg of the thermoplastic resins.

The above-mentioned curable resin precursors are compounds having functional groups to react by heat, an active energy beam (ultraviolet rays and electron beams), and the like, and compounds capable of forming resins by curing or crosslinking by heat, an active energy beam and the like. Examples of the above-mentioned resin precursors include thermosetting compounds or resins [low molecular weight compounds (e.g. epoxy resins, unsaturated polyester resins, urethane resins, silicone resins) having epoxy groups, polymerizable groups, isocyanato groups, alkoxysilyl groups, silanol groups and the like], photo-curable compounds capable of curing by active light beam (ultraviolet rays and the like) (e.g. ultraviolet-hardening compounds such as photo-curable monomers and oligomers), and the photo-curable compounds may be EB (electron beam)-curable compounds and the like. Here, the photo-curable compounds such as photo-curable monomers and oligomers and photo-curable resins that may have low molecular weight may sometimes be referred simply to “photo-curable resins”.

The above-mentioned photo-curable compounds may be monomers or oligomers (or resins, particularly low molecular weight resins) and examples of the monomers include mono-functional monomers [(meth)acrylic monomers such as (meth)acrylic acid esters; vinyl monomers such as vinylpyrrolidone, and crosslinkable cyclic hydrocarbon group-containing (meth)acrylates such as isobornyl (meth)acrylate, and adamantyl (meth)acrylate] and polyfunctional monomers having at least two polymerizable unsaturated bonds [e.g. alkylene glycol di(meth)acrylate such as ethylene glycol di(meth)acrylate, propylene glycol di(meth)acrylate, butanediol di(meth)acrylate, neopentyl glycol di(meth)acrylate, and hexanediol di(meth)acrylate; (poly)oxyalkylene glycol di(meth)acrylate such as diethylene glycol di(meth)acrylate, dipropylene glycol di(meth)acrylate, and polyoxytetramethylene glycol di(meth)acrylate; crosslinkable cyclic hydrocarbon group-containing di(meth)acrylate such as tricyclodecane dimethanol di(meth)acrylate, and adamantane di(meth)acrylate; and polyfunctional monomers having about 3 to 6 polymerizable unsaturated bonds such as trimethylolpropane tri(meth)acrylate, trimethylolethane tri(meth)acrylate, pentaerythritol tri(meth)acrylate, pentaerythritol tetra(meth)acrylate, and dipentaerythritol penta(meth)acrylate.

Examples of the oligomer or resins include (meth)acrylate of bisphenol A-alkylene oxide adducts, epoxy (meth)acrylate (such as bisphenol A epoxy (meth)acrylate and novolak epoxy (meth)acrylate), polyester (meth)acrylate (e.g. aliphatic polyester (meth)acrylate and aromatic polyester (meth)acrylate), (poly)urethane (meth)acrylate (e.g. polyester urethane (meth)acrylate and polyether urethane (meth)acrylate), and silicone (meth)acrylate. These photo-curable compounds may be used alone or in combination of two or more kinds.

The above-mentioned curable resin precursors are preferably photo-curable compounds to be cured within a short time and examples are ultraviolet-curable compounds (monomers, oligomers and resins with low molecular weights), EB-curable compounds. Particularly, practically advantageous resin precursors are ultraviolet-curable compounds. Further, in order to improve the resistance such as scratching resistance, the photo-curable resins are preferably compounds having 2 or more (preferably 2 to 6 and more preferably 2 to 4) polymerizable unsaturated bonds. The molecular weight of the curable resin precursors may be 5000 or less, preferably 2000 or less, and more preferably 1000 or less in consideration of compatibility with polymers.

The above-mentioned polymers and the above-mentioned curable resin precursors have glass transition temperature of, for example, −100° C. to 250° C., preferably −50° C. to 230° C., and more preferably 0° C. to 200° C. (e.g. about 50 to 180° C.). Here, in terms of the surface hardness, the glass transition temperature is advantageously 50° C. or higher (e.g. about 70 to 200° C.) and preferably 100° C. or higher (e.g. about 100 to 170° C.). The weight average molecular weight of the polymers may be selected from a range of 1000000 or less and preferably about 1000 to 500000.

The curable resin precursors may be used in combination with a curing agent based on the necessity. For example, in a thermosetting resin precursor, a curing agent of amines, polycarboxylic acids and the like may be used in combination. The content of the curing agent is 0.1 to 20 parts by weight, preferably 0.5 to 10 parts by weight, and more preferably about 1 to 8 parts by weight (particularly 1 to 5 parts by weight) based on 100 parts by weight of the curable resin precursor, and may be about 3 to 8 parts by weight. A photopolymerization initiator may be used in combination with the above-mentioned photo-curable resin precursors. As the above-mentioned photopolymerization initiator, compounds exemplified as usable compounds for a surface adjustment layer can be used.

The above-mentioned curable resin precursors may be used in combination with a curing promoter. For example, a photo-curable resin may contain a photo-curing promoter, for example, tertiary amines (e.g. dialkylaminobenzoic acid esters), phosphine photopolymerization promoter and the like.

In the above-mentioned method 2, at least two kind components are selected from the group consisting of the above-mentioned polymers and curable resin precursors and used. In the case of (a) combinations for causing phase separation due to non-compatible with a plurality of polymers with respect to one another, the above-mentioned polymers can be properly combined and used. For example, in the case where the first resin is styrene resin (polystyrene, styrene-acrylonitrile copolymers, and the like), examples that can be used as the second resin may be cellulose derivatives (e.g. cellulose esters such as cellulose acetate propionate), (meth)acrylic resins (such as poly(methyl methacrylate)), alicyclic olefin resins (such as polymers using norbornene as a monomer), polycarbonate resins, and polyester resins (such as the above-mentioned poly(C₂₋₄ alkylene arylate copolyesters). Further, for example, in the case where the first polymer is a cellulose derivative (e.g. cellulose esters such as cellulose acetate propionate), examples that can be used as the second polymer may be styrene resins (such as polystyrene, styrene-acrylonitrile copolymer), (meth)acrylic resins, alicyclic olefin resins (such as polymers using norbornene as a monomer), polycarbonate resins, and polyester resins (such as the above-mentioned poly(C₂₋₄ alkylene arylate copolyesters)). In a combination of a plurality of resins, at least cellulose esters (e.g. cellulose C₂₋₄ alkyl carboxylic acid esters such as cellulose diacetate, cellulose triacetate, cellulose acetate propionate, and cellulose acetate butyrate) may be used.

The proportion (weight ratio) of the first polymer and the second polymer may be selected from a range of the first polymer/second polymer of 1/99 to 99/1, preferably 5/95 to 95/5, and more preferably about 10/90 to 90/10 and in general, it is about 20/80 to 80/20 and particularly about 30/70 to 70/30.

The phase separation structure produced by the Spinodal decomposition is finally cured by active light beams (ultraviolet rays and electron beams) and heat to form a cured resin. Therefore, the hard coat layer (B) is provided with scratching resistance and durability can be improved.

In terms of the scratching resistance after curing, at least one polymer among a plurality of polymers, for example one polymer among mutually non-compatible polymers, (in the case of combining a first polymer and a second polymer, particularly both polymers) is preferably a polymer having functional groups reactive with the curable resin precursor in the side chains.

Examples of the polymer for forming the phase separation structure may contain the above-mentioned thermoplastic resins and other polymers besides the above-mentioned non-compatible two polymers.

Further, the above-mentioned curable resin precursors (particularly, monomers or oligomers having a plurality of curable functional groups) may also be used in combination with the combination of a plurality of the above-mentioned polymers. In this case, in terms of the scratching resistance after curing, one polymer (particularly, both polymers) among a plurality of the above-mentioned polymers may be thermoplastic resins having functional groups (functional groups relating to the curing of the above-mentioned curable resin precursors) relevant to the curing reaction. The thermoplastic resins and the curable resin precursors are preferably mutually non-compatible. In this case, at least one polymer may be non-compatible with the resin precursors and other polymers may be compatible with the above-mentioned resin precursors.

The proportion (weight ratio) of the polymer and the curable resin precursor may be selected from a range of the polymer/curable resin precursor of about 5/95 to 95/5 and in terms of the surface hardness, it is preferably 5/95 to 60/40 and more preferably about 10/90 to 50/5, and particularly preferably about 10/90 to 40/60.

In the case of causing phase separation by composing the polymer using a plurality of mutually non-compatible polymers, the curable resin precursors are preferably used in combination with at least one polymer compatible around a processing temperature among a plurality of mutually non-compatible polymers. That is, when a plurality of mutually non-compatible polymers are constituted with, for example, a first resin and a second resin, the curable resin precursors may be compatible with either one of the first resin and the second resin and preferably compatible with both of the polymer components. In the case where the precursors are compatible with both polymer components, phase separation occurs at least into two phases; a mixture of the first resin and the curable resin precursors as main components and a mixture of the second resin and the curable resin precursors as main components.

In the case where the compatibility of a plurality of the selected polymer is low, the polymers are effectively phase-separated during the drying step for evaporating the solvent to improve the function of the hard coat layer (B). The phase separation of a plurality of the polymers can easily be determined by observing visually whether remaining solid matter becomes opaque or not during the process of preparing a uniform solution using a good solvent for both components and gradually evaporating the solvent.

In general, the phase-separated two-phase components are different from each other in the refractive index. The difference of the refractive indexes of the above-mentioned phase-separated two-phase components is preferably, for example, 0.001 to 0.2 and more preferably 0.05 to 0.15.

In the above-mentioned composition for phase separation type hard coat layer (B), the solvent may be selected in accordance with types and solubility of the above-mentioned polymers and curable resin precursors to be used and may be a solvent which can evenly dissolve at least solid matter (a plurality of polymers and curable resin precursors, reaction initiators, and other additives) and can be used for wet type Spinodal decomposition. Examples of such a solvent may include ketones (acetone, methyl ethyl ketone, methyl isobutyl ketone, cyclohexanone, etc.), ethers (dioxane, tetrahydrofuran, etc.), aliphatic hydrocarbons (hexane, etc.), alicyclic hydrocarbons (cyclohexane, etc.), aromatic hydrocarbons (toluene, xylene, etc.), halogenated carbons (dichloromethane, dichloroethane, etc.), esters (methyl acetate, ethyl acetate, butyl acetate, etc.), water, alcohols (ethanol, isopropanol, butanol, cyclohexanol, etc.), cellosolves (methylcellosolve, ethylcellosolve, etc.), cellosolve acetates, sulfoxides (dimethyl sulfoxide, etc.), amides (dimethylformalmide, dimethylacetamide, etc.), and may be a mixture solvent thereof.

The concentration of the solutes (polymers and curable resin precursors, reaction initiators, and other additives) in the composition for phase separation type hard coat layer (B) may be selected to an extent that the phase separation is caused and that the casting property and coatability are not deteriorated and it is, for example, 1 to 80% by weight, preferably 5 to 60% by weight, and more preferably about 15 to 40% by weight (particularly 20 to 40% by weight).

### (Method 3) Method for Forming Hard Coat Layer (B) by Carrying Out Embossing Treatment for Surface Roughness

The method 3 is a method for forming a hard coat layer (B) having a surface roughness by forming a coating layer composed of a resin and carrying out molding treatment for providing the roughness to the surface of the coating layer. Such a method is preferably carried out by molding treatment using a mold having peaks and valleys which has a shape reversed to the surface roughness of the hard coat layer (B). The mold having peaks and valleys includes an emboss plate and an emboss roll.

In the method 3, the shape formation may be carried out by the mold having peaks and valleys after a composition for the hard coat layer (B) is applied; or a composition for the hard coat layer (B) may be supplied to the interface of the light-transmitting substrate on which the clear hard coat layer (A) is formed, and the mold having peaks and valleys and the composition for the hard coat layer (B) is interposed between the mold having peaks and valleys and the clear hard coat layer (A), and thus formation of the surface roughness and formation of the clear hard coat layer (B) may be carried out simultaneously. The composition for the hard coat layer (B) may contain fine particles or no fine particles selectively in accordance purposes. In the present invention, in place of the emboss roller, a flat type emboss plate may also be used.

A surface of the mold having peaks and valleys formed on such as an emboss roller or a flat emboss plate is formed by conventionally known various methods such as a sand blast method or a bead shot method. The hard coat layer (B) formed by using an emboss plate (an emboss roller) in accordance with a sand blast method is provided with a shape on the top side on which a large number of valleys are distributed. The hard coat layer (B) formed by using an emboss plate (an emboss roller) in accordance with a bead shot method is provided with a shape on the top side on which a large number of peaks are distributed.

In the case where the mean roughness of the surface roughness formed on the surface of the hard coat layer (B) is the same, in comparison of the hard coat layer (B) having a large number of the peaks distributed on the top side with that having a large number of the valleys distributed on the top side, reflection of lighting apparatuses or the like in an interior room is said to be less. Therefore, according to a preferable aspect of the present invention, it is preferable to form the surface roughness of the hard coat layer (B) by using an mold having peaks and valleys formed to have the same shape as the surface roughness of the hard coat layer (B) in accordance with the bead shot method.

As a mold material for forming the surface of the mold having peaks and valleys, plastics, metals, wood, and the like can be used and composites thereof may also be used. In terms of the strength and wear resistance because of repeat use, the mold material for forming the surface of the mold having peaks and valleys, metal chromium is preferable and in terms of economy or the like, an emboss plate (an emboss roller) made of iron and surface-plated with chromium is preferable.

At the time of forming the mold having peaks and valleys in accordance with a sand blast method or a bead shot method, specific examples of particles (beads) to be blown include metal particles and inorganic particles such as silica, alumina, and glass. The particle size (diameter) of these particles is preferably about 100 μm to 300 μm. At the time of blowing these particles to the mold material, a method of blowing these particles together with a high speed gas may be used. At that time, a proper liquid, for example, water or the like may be used in combination. Further, in the present invention, in order to improve the durability for use, the mold having peaks and valleys is preferably plated with chromium or the like before using in terms of curing the coat and prevention of corrosion.

The above-mentioned composition for the hard coat layer (B) may contain the additives or the like described for the above-mentioned clear hard coat layer (A).

The optical layered body of the present invention is desirable to have pencil hardness of 4H or higher at a load of 4.9 N in the state that the clear hard coat layer (A) and the hard coat layer (B) are formed. This layered body is desirable to have Vicker's hardness of 550 N/mm or higher.

The thickness of the above-mentioned clear hard coat layer (A) and the hard coat layer (B) may properly be set in accordance with the desired characteristics or the like; however it is preferably 0.1 to 100 μm and more preferably 0.8 to 20 μm. The above-mentioned thickness can be measured by the following method.

### (Layer Thickness: Method for Measuring Total Thickness)

A cross section of the optical layered body was transmission-observed by a confocal laser microscope (Leica TCS-NT: manufactured by Leica: magnification 300 to 1000 times) to determine presence or absence of interfaces and a determination was made based on the following evaluation standard. Specifically, in order to obtain a clear image without halation, a wet type object lens was used for the confocal laser microscope and about 2 ml of an oil with refractive index of 1.518 was put on the optical layered body for the observation and the determination was carried out. Use of the oil was for eliminating an air layer between the object lens and the optical layered body. With respect to the hard coat layer (B) having the surface roughness, the thickness was measured at each point in total two points; the maximum peak top and the minimum valley bottom of the surface roughness on the outermost surface from the substrate for each image obtained by the measurement and an average value of 5 images, that is, in total 10 points was calculated. With respect to the thickness of the clear hard coat layer (A), measurement was carried out at one point for each one image and the average value was calculated by measuring the thickness for 5 images, that is, at 5 points in total.

The above-mentioned laser microscope can carry out nondestructive cross sectional observation due to the existence of refractive index difference for the respective layers. Accordingly, if the refractive index difference is unclear or the difference is close to 0, the thickness of the clear hard coat layer (A) and the hard coat layer (B) can be measured by observation of SEM and TEM cross-section photographics, which are capable of observation based on the composition difference of the respective layers and the respective average values can be calculated by observing 5 images in the same manner.

With respect to the optical layered body of the present invention, the surface haze value due to the surface roughness of the hard coat layer (B) is preferably 0.2 to 30. The reason in which this range is preferable is because the antiglare property becomes insufficient in the case of the surface roughness having no haze of 0.2 or higher and because the image becomes white and mat although excellent in the antiglare property and thus black color reproducibility cannot be obtained in the case of the surface roughness having haze higher than 30.

“Surface haze” can be measured in the following manner. A mixture obtained by properly mixing an acrylic monomer such as pentaerythritol triacrylate and other oligomers or polymers, diluting with toluene and adding a proper initiator or the like and adjusted so as to have a solid matter content of 60% is applied to the surface roughness of the hard coat layer (B) (a surface adjustment layer or the outermost layer among arbitrary layers in the case where the arbitrary layers described below are formed) by a wire bar and dried and cured to give a dried film having thickness of 8 μm. Accordingly, the surface roughness of the hard coat layer (B) (the outermost layer among arbitrary layers in the case where the arbitrary layers are formed) are eliminated to give a flat layer. In the case where a leveling agent or the like is added to the composition for forming the hard coat layer (B) or the arbitrary layer and thus a re-coating agent tends to be repelled and hard to be wet, an antiglare film may previously be subjected to saponification treatment (by immersing the film in a 2 mol/L of NaOH (or KOH) solution at 55° C. for 3 minutes and successively washing the film with water and completely removing the water droplets with Kim Wipe and further drying the film at 50° C. for 1 minute in an oven) to carry out hydrophilic treatment. The film with the leveled surface is in the state that the film has no haze due to the surface roughness but has only inside haze. Then, the haze can be calculated as the inside haze. The value calculated by subtracting the inside haze from the haze (whole body haze) of the original film is regarded as the haze (surface haze) attributed to the surface roughness.

The optical layered body of the present invention is an optical layered body having bilayered hard coat layer composed of the clear hard coat layer (A) and the hard coat layer (B). The above-mentioned optical layered body may have a primer layer between the clear hard coat layer (A) and the hard coat layer (B), based on the necessity. The above-mentioned primer layer is not particularly limited and may be formed by using a conventionally known primer coating composition such as a polyurethane resin primer coating composition. As the primer coating composition, a solvent having permeability to the clear hard coat layer (A) is preferably used in terms of interference fringe prevention. The above permeable solvents are examples for such a solvent.

The optical layered body of the present invention preferably has a surface adjustment layer further on the above-mentioned hard coat layer (B). Formation of the above-mentioned surface adjustment layer makes the layer united with the hard coat layer (B) and gives an antiglare function. That is, formation of the surface adjustment layer on the hard coat layer (B) smoothes peaks and valleys on the surface of the hard coat layer (B) and further provides surface roughness parameter in the above-mentioned range, so that a sufficient antiglare property can be obtained and at the same time an antiglare layered body with very high gloss blackness can be produced. As the surface roughness excellent particularly in the gloss blackness, φ preferably satisfies 0.0020≦φ≦0.0080 and θa preferably satisfies 0.3≦θa≦0.8.

In the case where the optical layered body of the present invention has the surface adjustment layer on the hard coat layer (B), the optical characteristic values (φ, Sm, θa, and Rz) of the surface roughness of the optical layered body are values of the outermost surface (the surface of the surface adjustment layer) on the optical layered body having the surface adjustment layer.

With respect to the surface adjustment layer, it is made possible to form smooth peaks and valleys (the peaks are like hills with gentle slope and the valleys are not valley-like but have an approximately flat shape) by filling fine peaks and valleys existing along the surface roughness in the scale of 1/10 or less of the rough scale (the peak height and the peak interval of the peaks and the valleys) on the roughness forming the surface roughness of the hard coat layer (B), or it is made possible to adjust the peak interval and the peak height of the peaks and valleys and the frequency (the number) of the peaks. It is made possible to obtain black (gloss blackness) excellent in the black color tone and seemed as black as a raven (clear and pure black color) by making the valleys of the surface roughness relatively flat. Further, the surface adjustment layer may also be formed for the purposes of imparting static electricity prevention, refractive index adjustment, hardness improvement, antifouling property and the like. The layer thickness (in the case of curing) of the surface adjustment layer is preferably 0.6 μm or thicker and 15 μm or thinner (preferably 12 μm or thinner) and more preferably 3 μm as the lower limit and 8 μm as the upper limit. Here, the thickness of the surface adjustment layer is a value calculated by measuring the thickness A of the hard coat layer by the above method and measuring the thickness B of the hard coat layer provided the surface adjustment layer+surface adjustment layer and subtracting the A value from B (in the case where there is refractive index difference between the hard coat layer and the binder resin of the surface adjustment layer, the calculation is possible by measuring A after B value measurement of the completed product). If the above-mentioned layer thickness is less than 0.6 μm, although the antiglare property is good, the gloss blackness cannot be improved in some cases. If the layer thickness exceeds 15 μm, although the gloss blackness is remarkably excellent, there sometimes occurs a problem that the antiglare property cannot be improved.

The above-mentioned surface adjustment layer contains the resin binder. The resin binder is not particularly limited; however those that are transparent are preferable and examples can include those obtained by curing ionizing radiation-curable resins, which are resins to be cured by ultraviolet rays or electron beams, a mixture of ionizing radiation-curable resins and solvent-drying resins, and those that can be obtained by curing thermosetting resins or the like. More preferred are ionizing radiation-curable resins. The ionizing radiation-curable resins, a mixture of ionizing radiation-curable resins and solvent-drying resins, and thermosetting resins are not particularly limited and resins exemplified as usable ones for forming the above-mentioned hard coat layer can be used.

The surface adjustment layer may also contain a fluidity adjustment agent such as organic fine particles and inorganic fine particles for adjusting the fluidity. The organic fine particles or inorganic fine particles usable for the fluidity adjustment agent are not particularly limited in the shape and for example, spherical, platy, fibrous, nonspherical, and hollow shapes are all acceptable. A particularly preferable fluidity adjustment agent is colloidal silica.

The “colloidal silica” in the present invention means a colloid solution obtained by dispersing silica powder in colloidal state in water or an organic solvent. The particle size (diameter) of the colloidal silica is preferably as small as ultrafine particles with about 1 to 50 nm. The particle size of the colloidal silica in the present invention means an average particle diameter measured by BET method (the average particle diameter is calculated by measuring the surface area by BET method and carrying out conversion into the diameter while assuming the particles to be truly spherical).

The above-mentioned colloidal silica is conventionally known and commercialized ones can include “Methanol Silica Sol” “MA-ST-M”, “IPA-ST”, “EG-ST”, “EG-ST-ZL”, “NPC-ST”, “D MAC-ST”, “MEK”, “XBA-ST”, and “MIBK-ST” (all are manufactured by Nissan Chemical Industries, Ltd.; all trade names), “OSCAL 1132”, “OSCAL 1232”, “OSCAL 1332”, “OSCAL 1432”, “OSCAL 1532”, “OSCAL 1632”, and “OSCAL 1132” (all are manufactured by Catalysts and Chemicals Industries Co., Ltd.; all trade names).

The above-mentioned organic fine particles or inorganic fine particles are preferably added in a fine particle weight ratio of 5 to 300 based on 100 of the binder resin weight of the surface adjustment layer (fine particle weight/binder resin weight=P/V ratio=(5 to 300)/100). If it is less than 5, the following property to the surface roughness becomes insufficient and therefore, it sometimes becomes difficult to satisfy both of black color reproducibility of gloss blackness and antiglare property. If it exceeds 300, since defects are caused in terms of physical properties such as adhesiveness and scratching resistance and therefore, it is preferably in the above-mentioned range. Although with the addition amount is depending on the fine particles to be added, it is preferably 5 to 80 in the case of colloidal silica. If it exceeds 80, the antiglare property is not fluctuated even if the particles are added furthermore and the addition becomes meaningless and if it exceeds the ratio, the adhesion to the lower layer become inferior and therefore, it is preferable to keep in the range.

The light-transmitting substrate is preferably those having smoothness and heat resistance and are excellent in mechanical strength. Specific examples of a material forming the light-transmitting substrate include thermoplastic resins such as polyesters (poly(ethylene terephthalate) and poly(ethylene naphthalate)), cellulose triacetate, cellulose diacetate, cellulose acetate butyrate, polyamides, polyimides, polyether sulfones, polysulfones, polypropylene, polymethylpentene, poly(vinyl chloride), polyvinyl acetals, polyether ketones, poly(methyl methacrylate), polycarbonates, and polyurethane and preferably include polyesters (poly(ethyleneterephthalate) and poly(ethylene naphthalate)) and cellulose triacetate.

As the above-mentioned light-transmitting substrate, films of amorphous olefin polymers (Cyclo-Olefin-Polymer: COP) having an alicyclic structure are also usable. The films are substrates using norbornene polymers, monocyclic olefin polymers, cyclic conjugated diene polymers, vinyl-alicyclic hydrocarbon polymer resins, and the like and examples include Zeonex and Zeonoa (norbornene resins) manufactured by Nippon Zeon Co., Ltd.; Sumilite FS-1700 manufactured by Sumitomo Bakelite Co., Ltd.; Arton (modified norbornene resin) manufactured by JSR Corporation; Apel (cyclic olefin copolymer) manufactured by Mitsui Chemicals Inc.; Topas (cyclic olefin copolymer) manufactured by Ticona; Optolets OZ-1000 series (alicyclic acrylic resins) manufactured by Hitachi Chemical Co., Ltd.; and the like. Further, as substitute substrates of triacetyl cellulose, FV series (low birefringence, low photoelasticity films) manufactured by Asahi Kasei Chemicals Ltd. are also preferable.

With respect to the light-transmitting substrate, the above-mentioned thermoplastic resins enriched with flexibility are preferably used in form of a film-like body and it is also possible to use these thermoplastic resin plates in accordance to the mode of use required for curability or plate bodies of glass plates may also be used.

The thickness of the light-transmitting substrate is preferably 20 μm or thicker and 300 μm or thinner and more preferably 200 μm as the upper limit and 30 μm as the lower limit. In the case where the light-transmitting substrate is a plate-like body, the thickness may exceeds these thickness values. The substrate may be subjected to physical treatment such as corona discharge treatment, oxidation treatment for improving the adhesiveness and also may previously coated with a coating composition, so-called anchor agent or primer, at the time of forming the antiglare layer, an antistatic layer or the like thereon.

The optical layered body of the present invention may properly have one or more other layers (a low refractive index layer, a antifouling layer, an antistatic layer, an adhesive layer, other hard coat layers, and the like) on the hard coat layer based on the necessity to an extent that the light transmitting property is not deteriorated. Particularly, the optical layered body is preferable to have a low refractive index layer. These layers may also be those that are the same for conventionally known antireflection layered body.

The above-mentioned low refractive index layer is a layer having a function of decreasing the reflectivity at the time the outside light (e.g. a fluorescent lamp, natural light and the like) is reflected on the surface of the optical layered body. The low refractive index layer preferably has a refractive index of 1.45 or lower and particularly preferably of 1.42 or lower.

Further, the dry thickness of the low refractive index layer is not limited; however it is, in general, selected properly in a range of about 30 nm to 1 μm.

The above-mentioned low refractive index layer is constituted with preferably any of 1) a resin containing silica or magnesium fluoride; 2) a fluororesin, which is a low refractive index layer; 3) a fluororesin containing silica or magnesium fluoride; and 4) a thin film of silica or magnesium fluoride. With respect to the resins other than the above-mentioned fluororesin, resins that are the same as those constituting the above-mentioned hard coat layer composition can be employed.

As the above-mentioned fluororesin, a polymerizable compound containing fluorine atoms at least in a molecule or a polymer thereof can be used. The polymerizable compound is not particularly limited, but for example, polymerizable compounds having a curing reactive group such as a functional group to be cured by ionizing radiation, a thermosetting polar group or the like are preferable. Further, compounds having these reactive groups simultaneously together may also be used. In contrast to this polymerizable compound, the polymer is a polymer not having the above reactive group at all.

As polymerizable compounds having an ionizing radiation-curable group containing fluorine atoms, fluorine-containing monomers having an ethylenic unsaturated bond can be widely employed. More specifically, fluorolefins (for example, fluoroethylene, vinylidene fluoride, tetrafluoroethylene, hexafluoropropylene, perfluorobutadiene, perfluoro-2,2-dimethyl-1,3-dioxole, etc.) can be exemplified. Examples of polymerizable compounds having a (meth)acryloyloxy group include a (meth)acrylate compound having fluorine atoms in a molecule such as 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluoroctyl)ethyl (meth)acrylate, 2-(perfluorodecyl)ethyl (meth)acrylate, α-trifluoromethylmethacrylic acid and α-trifluoroethylmethacrylic acid; and fluorine-containing polyfunctional (meth)acrylic acid ester compounds having a fluoroalkyl group, a fluorocycloalkyl group or a fluoroalkylene group, having 1 to 14 carbon atoms, which has at least three fluorine atoms in a molecule, and at least two (meth) acryloyloxy groups.

As the thermosetting polar groups, for example, groups for forming a hydrogen bond such as a hydroxyl group, a carboxyl group, an amino group and an epoxy group are preferable. These groups are superior in not only the adhesion to a coat but also the affinity for an inorganic ultra fine particle such as silica.

Examples of the polymerizable compounds having the thermosetting polar group include 4-fluoroethylene-perfluoroalkylvinylether copolymer; fluoroethylene-hydrocarbonvinylether copolymer; and fluorine modified products of various resins such as epoxy, polyurethane, cellulose, phenol and polyimide.

As the polymerizable compounds having the ionizing radiation-curable group and the thermosetting polar group together, partially and fully fluorinated alkyl, alkenyl, or aryl esters of acrylic acid or methacrylic acid, fully or partially fluorinated vinyl ethers, fully or partially fluorinated vinyl esters, and fully or partially fluorinated vinyl ketones can be exemplified.

Further, examples of fluororesins include the following compounds.

Polymers of a monomer or a mixture of monomers, containing at least one fluorine-containing (meth)acrylate compound of the polymerizable compounds having the ionizing radiation-curable group; copolymers of at least one of above-mentioned fluorine-containing (meth)acrylate compounds and a (meth)acrylate compound not containing a fluorine atom in a molecule like methyl (meth)acrylate, ethyl (meth)acrylate, propyl (meth)acrylate, butyl (meth)acrylate and 2-ethylhexyl (meth)acrylate; and homopolymers or copolymers of fluorine-containing monomers like fluoroethylene, vinylidene fluoride, trifluoroethylene, chlorotrifluoroethylene, 3,3,3-trifluoropropylene, 1,1,2-trichloro-3,3,3-trifluoropropylene and hexafluoropropylene. Silicone-containing vinylidene fluoride copolymer prepared by including a silicone component in these copolymers can also be used.

The above-mentioned silicone component is not particularly limited and examples include (poly) dimethylsiloxane, (poly) diethylsiloxane, (poly) diphenylsiloxane, (poly)methylphenylsiloxane, alkyl-modified (poly) dimethylsiloxane, azo group-containing (poly) dimethylsiloxane, dimethylsilicone, phenylmethylsilicone, alkyl/aralkyl-modified silicone, fluorosilicone, polyether-modified silicone, fatty acid ester-modified silicone, methyl hydrogenated silicone, silanol group-containing silicone, alkoxyl group-containing silicone, phenol group-containing silicone, methacryl-modified silicone, amino-modified silicone, carboxylic acid-modified silicone, carbinol-modified silicone, epoxy-modified silicone, mercapto-modified silicone, fluoro-modified silicone, polyether-modified silicone, and the like. Among them, those having a dimethylsiloxane structure are preferable.

Since polydimethylsiloxane polymers are preferably used since the contact angle can be widened in terms of the characteristics. Specific examples of such siloxanes include mixtures obtained by adding various kinds of crosslinking agents, e.g. tetrafunctional silanes such as tetraacetoxysilane, tetraalkoxysilane, tetraethylmethylketoximesilane, tetraisopropenylsilane, and the like; and also trifunctional silanes such as alkyl or alkenyltriacetoxysilane, triketoximesilane, triisopropenylsilane, trialkoxysilane, and the like to polyalkyl-, polyalkenyl-, and polyarylsiloxane such as polydimethylsiloxane, polymethylphenylsiloxane and polymethylvinylsiloxane having silanol group at terminals, and in some cases, previously reacted mixtures.

Furthermore, nonpolymers or polymers including following compounds can also be used as a fluororesin. That is, compounds obtained by reacting a fluorine-containing compound having at least one isocyanate group in a molecule with a compound having at least one functional group, such as an amino group, a hydroxyl group or a carboxyl group, which reacts with an isocyanate group in a molecule; and compounds obtained by reacting fluorine-containing polyol such as fluorine-containing polyether polyols, fluorine-containing alkyl polyols, fluorine-containing polyester polyols or fluorine-containing ∈-caprolactone modified polyols with a compound having an isocyanate group can be used.

Further, together with the above-mentioned polymerizable compounds or polymers having fluorine atoms, respective resin components described in the composition for the hard coat layer may also be used while being mixed. Furthermore, a curing agent for curing reactive groups, various kinds of additives for improving the coatability and giving antifouling property, and solvents may properly be used.

In addition to this, the low refractive index layer may be constituted with a thin film composed of SiO₂. For example, the layer may be formed by any method such as an evaporation method, a sputtering method, a vapor phase method such as a plasma CVD method, a liquid phase method for forming SiO₂ gel film from a sol solution containing SiO₂ sol. Further, other than SiO₂, the low refractive index layer can be constituted with a material such as a MgF₂ thin film. Particularly, from a viewpoint that the adhesiveness to the lower layer is high, a SiO₂ thin film is preferable. Further, among the above-mentioned techniques, in the case where the plasma CVD method is employed, it is preferable to use an organosiloxane as a raw material gas in a condition that no other inorganic evaporation source exists. Further, in this case, the method is preferably carried out while the object to be coated is kept at a temperature as low as possible.

In the case of forming the low refractive index layer, it can be formed by using a composition containing, for example, raw material components (a composition for a low refractive index layer). More specifically, a solution or a dispersion obtained by dissolving or dispersing the raw material components (resins and the like) and, based on necessity, additives (e.g. “fine particles having voids” described below, a polymerization initiator, an antistatic agent, an antiglare agent, and the like) in a solvent is used as a composition for the low refractive index layer and a coat is formed using the composition and the coat is cured to form the low refractive index layer. Additionally, the additives such as a polymerization initiator, an antistatic agent, an antiglare agent, and the like are not particularly limited and conventionally known ones can be exemplified.

In the low refractive index layer, “fine particles having voids” are preferably used as a low refractive index agent. The “fine particles having voids” can reduce the refractive index of the low refractive index layer while maintaining layer strength of the low refractive index layer. In the present invention, the term “fine particles having voids” means particles having a structure in which the inside of the particle is filled with vapor and/or a porous structure including vapor is formed, and a characteristic that the refractive index is decreased in inverse proportion to a proportion which the vapor makes up of the particle compared with the particle's own refractive index. Further, in the present invention, the particle having voids includes a fine particle, in which a nano porous structure can be formed inside the coat and/or in at least a part of the coat surface, based on the configuration, the structure and the agglomerated state of the fine particles and the dispersed state of fine particles within a coat. The refractive index of the low refractive index layer using this fine particle can be adjusted to a refractive index of 1.30 to 1.45.

Examples of the inorganic fine particles having voids include silica fine particles produced by a method described in Japanese Kokai Publication 2001-233611. Further, silica particles obtained by production methods described in such as Japanese Kokai Publication Hei-7-133105, Japanese Kokai Publication 2002-79616, and Japanese Kokai Publication 2006-106714, may be used. Since the silica fine particle having voids is easily produced and has high particle's own hardness, their layer strength is improved and it becomes possible to adjust the refractive index to a range of about 1.20 to 1.45 when the particles are mixed with the binder to form the surface adjustment layer. Particularly, specific preferable examples of organic fine particles having voids include hollow polymer particles prepared by use of a technique disclosed in Japanese Kokai Publication 2002-80503.

Examples of the fine particle, in which a nano porous structure can be formed inside the coat and/or in at least a part of the coat surface, include, in addition to the silica particles previously described, a slow-release agent produced for the purpose of increasing a specific surface area, in which various chemical substances is adsorbed on a column for filling and a porous portion of the surface, porous particles used for fixing a catalyst, and dispersed substances or agglomerated substances of hollow particles for the purpose of incorporating in a heat insulating material or a low dielectric material. Specifically, it is possible to select and use the particles within the range of the preferable particle diameter of the present invention from agglomerated substances of porous silica fine particles of commercially available Nipsil or Nipgel (both trade name) produced by Nihon Silica Kogyo Co., Ltd., and colloidal silica UP series (trade name), having a structure in which silica particles are linked with one another in a chain form, produced by Nissan Chemical Industries, Ltd.

An average particle diameter of the “fine particle having voids” is 5 nm or more and 300 nm or less, and preferably, a lower limit is 8 nm and an upper limit is 100 nm, and more preferably, the lower limit is 10 nm and the upper limit is 80 nm. It becomes possible to impart excellent transparency to the low refractive index layer by having the average particle diameter of the fine particles of this range. In addition, the above average particle diameter was measured by a dynamic light-scattering method. An amount of the “particles having voids” is usually about 0.1 to 500 parts by weight with respect to 100 parts by weight of a matrix resin in the low refractive index layer, and preferably about 10 to 200 parts by weight.

The above-mentioned solvent is not particularly limited and examples include those exemplified above in the composition for the hard coat layer and are preferably methyl isobutyl ketone, methyl ethyl ketone, cyclohexanone, isopropyl alcohol (IPA), n-butanol, tert-butanol, diethyl ketone, PGME, and the like.

A production method of the above-mentioned composition for the low refractive index layer is sufficient if components are mixed evenly and it can be carried out in accordance with a conventional method. For example, mixing may be carried out by using the conventionally known apparatus described above for formation of the hard coat layer.

A formation method of a coat may be a conventionally known method. For example, various methods for forming the hard coat layer as described above may be employed.

In forming the low refractive index layer, it is preferable to set the viscosity of the composition for a low refractive index layer in a range of 0.5 to 5 cps (25° C.) where a preferable application property is attained, and preferably 0.7 to 3 cps (25° C.). An excellent antireflection coat of visible light can be realized, a uniform thin coat can be formed without producing irregularity of application, and a low refractive index layer having particularly excellent adhesion to the substrate can be formed.

A curing method for the obtained coat may properly be selected in accordance with the contents of the composition.

For example, in the case of an ultraviolet-curable type, curing may be carried out by radiating ultraviolet rays to the coat. In the case of using heating means for curing treatment, for example, it is preferable to add a thermal polymerization initiator for starting polymerization of a polymerizable compound by generating radicals with heating.

A layer thickness (nm) d_{A} of the low refractive index layer preferably satisfies the following equation (V):

d_{A}=mλ/(4n_{A}) (V),

wherein n_{A} represents a refractive index of the low refractive index layer,
m represents a positive odd and preferably 1, and
λ is a wavelength and preferably values from 480 to 580 nm.

Further, in the present invention, it is preferable from the viewpoint of reducing a reflection factor that the low refractive index layer satisfies the following equation (VI):

120<n_{A}d_{A}<145 (VI).

The above-mentioned antifouling layer is a layer taking a role of making the outermost surface of the optical layered body hardly stained (finger prints, water-based or oil-based inks, pencils, and the like) or making it easy to wipe out the stains even in the case of stains are deposited. According to a preferable aspect of the present invention, in order to prevent stains on the outermost surface of the low refractive index layer, a antifouling layer may be formed and it is particularly preferable to form the antifouling layer on both sides, on one face of the light-transmitting substrate bearing the low refractive index layer formed thereon and on the other opposed face. Formation of the antifouling layer can further improve antifouling property and scratch resistance for the optical layered body. Even if there is no low refractive index layer, an antifouling layer may be formed to prevent stains on the outermost surface.

The antifouling layer can generally be formed by using a composition containing a antifouling agent and a resin. The antifouling agent is mainly for preventing stains of the outermost surface of the optical layered body and can also provide scratching resistance to the optical layered body. The above-mentioned antifouling agent may include fluoro compounds, silicon compounds, and a mixture thereof. More specifically, fluoroalkyl group-containing silane coupling agents such as 2-perfluoroctylethyltriaminosilane can be exemplified and particularly, those having amino groups are preferably usable. The above-mentioned resin is not particularly limited and the resins exemplified in the composition for the hard coat layer can be included.

The antifouling layer can be formed on the hard coat layer (B). Particularly, it is desired to form the antifouling layer in a manner that the layer forms the outermost surface. The antifouling layer can be substituted with the hard coat layer (B) by giving the layer an antifouling function.

The optical layered body of the present invention may further include an antistatic layer. The antistatic layer can be formed by using a composition containing an antistatic agent and a resin. The resin is not particularly limited and the resins exemplified in the composition for the hard coat layer can be included.

The antistatic agent is not particularly limited, and examples of the antistatic agent include a quaternary ammonium salt, a pyridinium salt, and various cationic compounds having a cationic group such as a primary, a secondary, and a tertiary amino group; anionic compounds such as a sulfonate group, a sulfate group, a phosphate group and a phosphonate group; ampholytic compounds such as amino acid and aminosulfate; nonionic compounds such as amino alcohol, glycerin and polyethylene glycol; organic metal compounds such as alkoxide tin or titanium; and metal chelate compounds such as acetylacetonate salt of the organic metal compound. As the antistatic agent, compounds formed by polymerizing the compounds described above can also be used. Further, polymerizable compounds such as monomer or oligomer which has a tertiary amino group, a quaternary ammonium group or a metal chelate portion and is polymerizable with ionizing radiation, and organic metal compounds like a coupling agent having a functional group can also be used as an antistatic agent.

Conductive polymers may also be included as the antistatic agent. The conductive polymers are not particularly limited and examples can be included such as aromatic conjugated poly(paraphenylene), heterocyclic conjugated polypyrrole, polythiophene, polyisocyanaphthene, aliphatic conjugated polyacetylene, polyacene, polyazulene, heteroatom-containing conjugated polyaniline, polythienylene vinylene, mixed type conjugated poly(phenylenevinylene), plural type conjugated systems, which are conjugated systems having a plurality of conjugated chains in molecules, conductive composites, which are polymers, obtained by graft- or block-copolymerizing saturated polymers with the above-mentioned conjugated polymer chains, and derivatives of these conductive polymers.

Among them, organic antistatic agents such as polythiophene, polyaniline, polypyrrole, and the like are preferable to be used. Use of the above-mentioned organic antistatic agents makes it possible to exhibit excellent antistatic property and at the same time increase the total luminous transmittance of the optical layered body and lower the haze value. Further, in order to improve the conductivity and antistatic property, an anion such as an organic sulfonic acid and iron chloride may also be added as a dopant (an electron donor agent). Due to also the dopant addition effect, particularly polythiophene is preferable because of high transparency and antistatic property. As the above-mentioned polythiophene, oligothiophene is also preferably usable. The derivatives of the conductive polymers are not particularly limited and examples may include alkyl group-substituted bodies of polyphenylacetylene, polydiacetylene and the like.

The antistatic agent may be a conductive metal oxide fine particle. The conductive metal oxide fine particle is not particularly limited, and examples of the conductive metal oxide fine particle include ZnO (refractive index 1.90, hereinafter, values in a parenthesis all represent a refractive index), Sb₂O₂ (1.71), SnO₂ (1.997), CeO₂ (1.95), indium tin oxide (abbreviation; ITO, 1.95), In₂O₃ (2.00), Al₂O₃ (1.63), antimony-doped tin oxide (abbreviation; ATO, 2.0), and aluminum-doped zinc oxide (abbreviation; AZO, 2.0). A fine particle refers to a particle having an average particle diameter of 1 micron or less, that is sub micron, and it is preferably a particle having an average particle diameter of 0.1 nm to 0.1 μm in that a composition capable of forming a highly transparent film, in which haze is little found and a total light transmittance is good, in dispersing the fine particles in the binder can be prepared. The average particle diameter of the conductive metal oxide fine particle can be measured by a dynamic light-scattering method.

The present invention causes a desired effect by controlling the shape of the surface of the hard coat layer (B), and keeping its θa, and φ in the above-mentioned ranges. That is, the optical characteristics are controlled by controlling the shape of the surface of the optical layered body of the present invention. Herein, the “surface of the optical layered body” means the outermost surface to be brought into contact with air even in the case where the above-mentioned optical layered body has arbitrary layers, and optical characteristic values of the surface roughness of the outermost surface are coincident with the optical characteristic values of the surface roughness of the optical layered body in the present invention.

In the optical layered body of the present invention, the total thickness of the layered body composed of the clear hard coat layer (A) and the hard coat layer (B), and arbitrary layers formed based on the necessity is preferably 4 to 25 μm. Adjustment of the total thickness in the above-mentioned range makes it possible to obtain aimed physical properties such as hardness, give excellent production stability, and prevents cracking and curling (the optical layered body is curled because of formation of the hard coat layer and it results in a bad effect on the steps thereafter) and therefore, it is preferable.

The optical layered body of the present invention can be produced by a method involving steps of forming a clear hard coat layer (A) by applying a composition for the clear hard coat layer (A) to the surface of a light-transmitting substrate produced, for example, from triacetyl cellulose as a raw material, and forming a hard coat layer (B) by applying a composition for the hard coat layer (B) on the clear hard coat layer (A). The method for producing the optical layered body of the present invention is also within a scope of the present invention.

In the method for producing the optical layered body of the present invention, the steps of forming the clear hard coat layer (A) and forming the hard coat layer (B) may include the same method as the above-mentioned method for forming the clear hard coat layer (A) and forming the hard coat layer (B).

According to the method for producing the optical layered body of the present invention, it is made possible substantially eliminate any interface existing between the light-transmitting substrate obtained using triacetyl cellulose as a raw material and the clear hard coat layer (A) formed on the light-transmitting substrate.

The optical layered body of the present invention is formed on the surface of a polarizing element opposed to a face where the hard coat layer of the optical layered body is present to give a polarizer. Such a polarizer is also within a scope of the present invention.

The above-mentioned polarizing element is not particularly limited, and as the polarization element, for example, a polyvinyl alcohol film, a polyvinyl formal film, a polyvinyl acetal film or an ethylene-vinyl acetate copolymer saponified film, which is dyed with iodine or the like and stretched, can be used. In laminating the polarizing element and the optical layered body of the present invention, preferably, the light-transmitting substrate (preferably triacetyl cellulose film) is subjected to a saponification treatment. By the saponification treatment, adhesion becomes good and an antistatic effect can be attained.

The present invention also provides an image display device including the optical layered body or the polarizer on the outermost surface. The image display device may be a non-self-luminous image display device such as LCD or a self-luminous image display device such as PDP, FED, ELD (organic EL, inorganic EL), and CRT.

LCD, a representative example of the non-self-luminous type includes a transmissive display body and a light source apparatus for radiating the transmissive display body from the back face. In the case where the image display device of the present invention is LCD, the optical layered body of the present invention or the polarizer of the present invention is formed on the surface of this transmissive display body.

In the case where the present invention provides a liquid crystal display device having the optical layered body, the light source of the light source apparatus radiates light from a downside of the optical layered body. In addition, in an STN type liquid crystal display apparatus, a retardation plate may be inserted between the liquid crystal display element and the polarizer. If necessary, adhesive layers may be formed between respective layers of the liquid crystal display device.

The PDP, which is the self-luminous image display device, includes a surface glass substrate and a backside glass substrate which is located at a position opposite to the surface glass substrate with a discharge gas filled between these substrates. When the image display device of the present invention is a PDP, the PDP includes the optical layered body described above on the surface of the surface glass substrate or a front plate (glass substrate or film substrate) thereof.

The self-luminous image display device may be an ELD apparatus in which luminous substances of zinc sulfide or diamines materials to emit light through the application of a voltage are deposited on a glass substrate by vapor deposition and display is performed by controlling a voltage to be applied to the substrate, or image display devices such as CRT, which converts electric signals to light to generate visible images. In this case, the image display device includes the optical layered body described above on the outermost surface of each of the display devices or on the surface a front plate thereof.

The image display device of the present invention can be used for displays such as televisions, computers, and word processors in any case. Particularly, it can be suitably used for the surfaces of displays for high-resolution images such as CRTs, liquid crystal panels, PDPs and ELDs.

### EFFECT OF THE PRESENT INVENTION

According to the present invention, an optical layered body having both of sufficient hardness and good antiglare property can be obtained.

### BRIEF DESCRIPTIONS OF THE DRAWINGS

FIG. 1 shows one example of a production apparatus of an optical layered body used in Examples.

### EXPLANATION OF THE NUMERICAL SYMBOLS

40: Embossing apparatus
41: Light-transmitting substrate
42: Surface roughness
43: Coating head
44: Composition for hard coat layer (B)
45a: Nip roller
45b: Release roller
46: Pipe
47: Embossing roller
48: Curing apparatus
49: Slit

### BEST MODE FOR CARRYING OUT THE INVENTION

Hereinafter, the present invention will be described in more detail by way of examples, but the present invention is not to be construed to limit to these examples. “Part(s)” and “%” are based on weight unless otherwise specified.

### EXAMPLES

### Production of Composition for Clear Hard Coat Layer (A)

### Composition 1 for Clear Hard Coat Layer (A)

Polyester acrylate (M 9050; manufactured by Toagosei Chemical Industry Co., Ltd., tri-functional, molecular weight 418) 10 parts by weight

Polymerization initiator (Irgacure 184; manufactured by Ciba Specialty Chemicals Inc.) 0.4 parts by weight

Methyl ethyl ketone (hereinafter, referred to as “MEK”) 10 parts by weight

The above-mentioned materials were sufficiently mixed to obtain a composition. The composition was filtered by a polypropylene filter with pore diameter of 30 μm to produce a composition 1 for a clear hard coat layer (A).

### Composition 2 for Clear Hard Coat Layer (A)

Polyester acrylate (M 9050; manufactured by Toagosei Co., Ltd., tri-functional, molecular weight 418) 5 parts by weight

Urethane acrylate (DPHA 40H; manufactured by Nippon Kayaku Co., Ltd., deca-functional, molecular weight about 7000) 5 parts by weight

Polymerization initiator (Irgacure 184) 0.4 parts by weight

MEK 10 parts by weight

The above-mentioned materials were sufficiently mixed to obtain a composition. The composition was filtered by a polypropylene filter with pore diameter of 30 μm to produce a composition 2 for a clear hard coat layer (A).

### Composition 3 for Clear Hard Coat Layer (A)

Polyethylene glycol diacrylate (M 240; manufactured by Toagosei Co., Ltd., di-functional, molecular weight 302) 2 parts by weight

Urethane acrylate (DPHA 40H; manufactured by Nippon Kayaku Co., Ltd., deca-functional, molecular weight about 7000) 6 parts by weight

Urethane acrylate (BS 371; manufactured by Arakawa Chemical Industries, Ltd., deca- or more-functional, molecular weight about 40000) 2 parts by weight

Polymerization initiator (Irgacure 184) 0.4 parts by weight

MEK 10 parts by weight

The above-mentioned materials were sufficiently mixed to obtain a composition. The composition was filtered by a polypropylene filter with pore diameter of 30 μm to produce a composition 3 for a clear hard coat layer (A).

### Composition 4 for Clear Hard Coat Layer (A)

Urethane acrylate (Shikoh UV 3520-TL; manufactured by Nippon Synthetic Chemical Industry., Co., Ltd., di-functional, molecular weight about 14000) 10 parts by weight

Polymerization initiator (Irgacure 184) 0.4 parts by weight

MEK 10 parts by weight

The above-mentioned materials were sufficiently mixed to obtain a composition. The composition was filtered by a polypropylene filter with pore diameter of 30 μm to produce a composition 4 for a clear hard coat layer (A).

### Composition for Hard Coat Layer (B)

### Composition 1 for Hard Coat Layer (B)

### (Ultraviolet Ray Curable Resin)

Polyfunctional urethane acrylate UV 1700B (manufactured by Nippon Synthetic Chemical Industry., Co., Ltd., deca-functional, molecular weight about 2000, refractive index 1.51) 0.9 parts by weight

Pentaerythritol triacrylate (PETA) (refractive index 1.51) 2.1 parts by weight

Poly(methylmethacrylate) (molecular weight 75000) 0.22 parts by weight

### (Photo-Curable Initiator)

Irgacure 184 (manufactured by Ciba Specialty Chemicals Inc.) 0.126 parts by weight

Irgacure 907 (manufactured by Ciba Specialty Chemicals Inc.) 0.021 parts by weight

### (First Light Transmitting Fine Particles)

Mono-dispersed acrylic beads (particle diameter 5 μm, refractive index 1.535) 0.44 parts by weight

### (Second Light Transmitting Fine Particles)

Nonspherical silica (average particle diameter 1.5 μm, hydrophobic organic treatment was carried out on particle surfaces) 0.044 parts by weight

### (Leveling Agent)

Silicone leveling agent 0.011 parts by weight

A solvent mixture of toluene/cyclohexanone=8/2 was added to the above-mentioned materials and the mixture was sufficiently mixed to obtain a composition having a solid matter content of 40.5% by weight. The composition was filtered by a polypropylene filter with pore diameter of 30 μm to produce a composition 1 for a hard coat layer (B).

### Composition 2 for Hard Coat Layer (B)

### (Ultraviolet Ray Curable Resin)

Polyfunctional urethane acrylate UV 1700B (manufactured by Nippon Synthetic Chemical Industry., Co., Ltd., deca-functional, molecular weight about 2000, refractive index 1.51) 1.10 parts by weight

Pentaerythritol triacrylate (PETA) (refractive index 1.51) 1.10 parts by weight

Isocyanuric acid-modified diacrylate M215 (manufactured by Nippon Kayaku Co., Ltd., refractive index 1.51) 1.21 parts by weight

Poly(methylmethacrylate) (molecular weight 75000) 0.34 parts by weight

### (Photo-Curable Initiator)

Irgacure 184 (manufactured by Ciba Specialty Chemicals Inc.) 0.22 parts by weight

Irgacure 907 (manufactured by Ciba Specialty Chemicals Inc.) 0.04 parts by weight

### (First Light Transmitting Fine Particles)

Mono-dispersed acrylic beads (particle diameter 9.5 μm, refractive index 1.535) 0.82 parts by weight

### (Second Light Transmitting Fine Particles)

Nonspherical silica ink (average particle diameter 1.5 μm, solid matter 60%, silica component 15% in total solid matter) 1.73 parts by weight

### (Leveling Agent)

Silicone leveling agent 0.02 parts by weight

### (Solvent)

Toluene 5.88 parts by weight

Cyclohexanone 1.55 parts by weight

The above-mentioned materials were sufficiently mixed to obtain a composition having a solid matter content of 40.5% by weight. The composition was filtered by a polypropylene filter with pore diameter of 30 μm to produce a composition 2 for a hard coat layer (B).

### Composition 3 for Hard Coat Layer (B)

### (Ultraviolet Ray Curable Resin)

Polyfunctional urethane acrylate UV 1700B (manufactured by Nippon Synthetic Chemical Industry., Co., Ltd., deca-functional, molecular weight about 2000, refractive index 1.51) 30 parts by weight

Pentaerythritol triacrylate (PETA) (manufactured by Nippon Kayaku Co., Ltd., refractive index 1.51) 70 parts by weight

### (Polymer)

Poly(methyl methacrylate) (molecular weight 75000) 10 parts by weight

### (First Light Transmitting Fine Particles)

Mono-dispersed acrylic beads (particle diameter 7.0 μm, refractive index 1.535) 20 parts by weight

### (Second Light Transmitting Fine Particles)

Mono-dispersed styrene beads (particle diameter 3.5 μm, refractive index 1.60) 2.5 parts by weight

### (Third Light Transmitting Fine Particles)

Nonspherical silica (average particle diameter 2.5 μm, hydrophobic organic treatment for particle surfaces) 2 parts by weight

### (Photo-Curable Initiator)

Irgacure 184 (manufactured by Ciba Specialty Chemicals Inc.) 6 parts by weight

Irgacure 907 (manufactured by Ciba Specialty Chemicals Inc.) 1 parts by weight

### (Leveling Agent)

Silicone leveling agent 0.045 parts by weight

### (Solvent)

Toluene 158 parts by weight

Cyclohexanone 39.5 parts by weight

The above-mentioned materials were added properly and sufficiently mixed. The composition was filtered by a polypropylene filter with pore diameter of 30 μm to produce a composition 3 for a hard coat layer (B) with a solid matter content of 40.5% by weight.

### Composition 4 for Hard Coat Layer (B)

### (Ultraviolet Ray Curable Resin)

Polyfunctional urethane acrylate UV 1700B (manufactured by Nippon Synthetic Chemical Industry., Co., Ltd., deca-functional, molecular weight about 2000, refractive index 1.51) 30 parts by weight

Pentaerythritol triacrylate (PETA) (manufactured by Nippon Kayaku Co., Ltd., refractive index 1.51) 70 parts by weight

### (Polymer)

Poly(methyl methacrylate) (molecular weight 75000) 10 parts by weight

### (First Light Transmitting Fine Particles)

Mono-dispersed acrylic beads (particle diameter 7.0 μm, refractive index 1.535) 20 parts by weight

### (Second Light Transmitting Fine Particles)

Mono-dispersed styrene beads (particle diameter 3.5 μm, refractive index 1.60) 16.5 parts by weight

### (Third Light Transmitting Fine Particles)

Nonspherical silica (average particle diameter 2.5 μm) 2 parts by weight

### (Photo-Curable Initiator)

Irgacure 184 (manufactured by Ciba Specialty Chemicals Inc.) 6 parts by weight

Irgacure 907 (manufactured by Ciba Specialty Chemicals Inc.) 1 parts by weight

### (Leveling Agent)

Silicone leveling agent 0.045 parts by weight

### (Solvent)

Toluene 174.4 parts by weight

Cyclohexanone 43.6 parts by weight

The above-mentioned materials were added properly and sufficiently mixed. The composition was filtered by a polypropylene filter with pore diameter of 30 μm to produce a composition 4 for a hard coat layer (B) with a solid matter content of 40.5% by weight.

### Composition 5 for Hard Coat Layer (B)

### (Ultraviolet Ray Curable Resin)

Polyfunctional urethane acrylate BS371 (manufactured by Arakawa Chemical Industries, Ltd., deca- or higher-functional, molecular weight about 40000, refractive index 1.51) 6 parts by weight

Pentaerythritol triacrylate (PETA) (refractive index 1.51) 14 parts by weight

Cellulose acetate propionate (molecular weight 50000) 0.4 parts by weight

### (Photo-Curable Initiator)

Irgacure 184 (manufactured by Ciba Specialty Chemicals Inc.) 1.2 parts by weight

Irgacure 907 (manufactured by Ciba Specialty Chemicals Inc.) 0.2 parts by weight

### (Fine Particles)

Nonspherical silica (average particle diameter 1.5 μm) 0.88 parts by weight

### (Leveling Agent)

Silicone leveling agent 0.012 parts by weight

### (Solvent)

Toluene 35.4 parts by weight

Methyl isobutyl ketone 6.7 parts by weight

The above-mentioned materials were sufficiently mixed to obtain a composition. The composition was filtered by a polypropylene filter with pore diameter of 30 μm to produce a composition 5 for a hard coat layer (B) with a solid matter content of 35% by weight.

### Composition 6 for Hard Coat Layer (B)

### (Ultraviolet Ray Curable Resin)

Polyfunctional urethane acrylate UV 1700B (manufactured by Nippon Synthetic Chemical Industry., Co., Ltd., refractive index 1.51) 16 parts by weight

Isocyanuric acid-modified diacrylate M215 (manufactured by Toagosei Chemical Industry Co., Ltd.) 2 parts by weight

Poly(methyl methacrylate) (molecular weight 75000) 2 parts by weight

### (Photo-Curable Initiator)

Irgacure 184 (manufactured by Ciba Specialty Chemicals Inc.) 1.2 parts by weight

Irgacure 907 (manufactured by Ciba Specialty Chemicals Inc.) 0.2 parts by weight

### (Fine Particles)

Mono-dispersed styrene beads (particle diameter 3.5 μm, refractive index 1.60) 0.5 parts by weight

### (Leveling Agent)

Silicone leveling agent 0.0132 parts by weight

A solvent containing toluene:cyclohexane at 6:4 was added to the above-mentioned materials so as to adjust the total solid matter content of 40% and the mixture was sufficiently mixed to produce a composition. The composition was filtered by a polypropylene filter with pore diameter of 30 μm to produce a composition 6 for a hard coat layer (B).

### Composition 7 for Hard Coat Layer (B)

### (Resin)

Cellulose acetate propionate (manufactured by Eastman Chemical Japan Ltd., CAP 482-20) 0.95 parts by weight

Reactive oligomer [compound obtained by adding 3,4-epoxycyclohexenyl methylacrylate to a portion of carboxyl group of (meth)acrylic acid-(meth)acrylic acid ester copolymer; manufactured by Daicel-Cytec Company Ltd., Cyclomer P) 16.25 parts by weight

Dipentaerythritol hexaacrylate (DPHA) 15.8 parts by weight

### (Photo-Curable Initiator)

Irgacure 184 (manufactured by Ciba Specialty Chemicals Inc.) 1.25 parts by weight

### (Solvent)

Methyl ethyl ketone 51 parts by weight

Butanol 17 parts by weight

The above-mentioned materials were added properly and sufficiently mixed. The composition was filtered by a polypropylene filter with pore diameter of 30 μm to produce a composition 7 for a hard coat layer (B) with a solid matter content of 33.5% by weight.

### Composition 8 for Hard Coat Layer (B)

### (Ultraviolet Ray Curable Resin)

Polyfunctional urethane acrylate BS371 (manufactured by Arakawa Chemical Industries, Ltd., deca- or higher-functional, molecular weight about 40000, refractive index 1.51) 8 parts by weight

Pentaerythritol triacrylate (PETA) (refractive index 1.51) 12 parts by weight

Cellulose acetate propionate (molecular weight 50000) 0.4 parts by weight

### (Photo-Curable Initiator)

Irgacure 184 (manufactured by Ciba Specialty Chemicals Inc.) 1.2 parts by weight

Irgacure 907 (manufactured by Ciba Specialty Chemicals Inc.) 0.2 parts by weight

### (Fine Particles)

Nonspherical silica (average particle diameter 1.5 μm, subjected to hydrophobic surface treatment with a silane coupling agent) 0.46 parts by weight

Nonspherical silica (average particle diameter 1.0 μm, subjected to hydrophobic surface treatment with a silane coupling agent) 0.46 parts by weight

### (Leveling Agent)

Silicone leveling agent 0.012 parts by weight

### (Solvent)

Toluene 15.6 parts by weight

Propylene glycol monomethyl ether acetate 20.3 parts by weight

Methyl isobutyl ketone 6.3 parts by weight

The above-mentioned materials were sufficiently mixed to obtain a composition. The composition was filtered by a polypropylene filter with pore diameter of 30 μm to produce a composition 8 for a hard coat layer (B) with a solid matter content of 35% by weight.

### Composition 9 for Hard Coat Layer (B)

### (Ultraviolet Ray Curable Resin)

Polyfunctional urethane acrylate UV 1700B (manufactured by Nippon Synthetic Chemical Industry., Co., Ltd., refractive index 1.51) 18 parts by weight

Poly(methyl methacrylate) (molecular weight 75000) 2 parts by weight

### (Photo-Curable Initiator)

Irgacure 184 (manufactured by Ciba Specialty Chemicals Inc.) 1.32 parts by weight

Irgacure 907 (manufactured by Ciba Specialty Chemicals Inc.) 0.22 parts by weight

### (Fine Particles)

Mono-dispersed acryl-styrene beads (particle diameter 7.0 refractive index 1.55) 1.5 parts by weight

### (Leveling Agent)

Silicone leveling agent 0.09 parts by weight

A solvent containing toluene:cyclohexane at 8:2 was added to the above-mentioned materials so as to adjust the total solid matter content of 45% and the mixture was sufficiently mixed to produce a composition. The composition was filtered by a polypropylene filter with pore diameter of 30 μm to produce a composition 9 for a hard coat layer (B).

### Composition 10 for Hard Coat Layer (B)

### (Ultraviolet Ray Curable Resin)

Polyfunctional urethane acrylate HDP (manufactured by Negami Chemical Industrial Co., Ltd., deca-functional, molecular weight 4500, refractive index 1.51) 10 parts by weight

Pentaerythritol triacrylate (PETA) (refractive index 1.51) 40 parts by weight

### (Photo-Curable Initiator)

Irgacure 184 (manufactured by Ciba Specialty Chemicals Inc.) 1.50 parts by weight

Irgacure 907 (manufactured by Ciba Specialty Chemicals Inc.) 1.50 parts by weight

After PETA was heated at 40° C. for 1 hour in an oven, two kinds of photo-curable initiators were slowly added and stirred and the mixture was further heated at 40° C. for another 1 hour man oven, and thereafter, again stirred to completely dissolve the photo-curable initiators and obtain a composition 10 for a hard coat layer (B) with 100% by weight of solid matter.

### Composition 11 for Hard Coat Layer (B)

### (Ultraviolet Ray Curable Resin)

Polyfunctional urethane acrylate UV 6300B (manufactured by Nippon Synthetic Chemical Industry., Co., Ltd., refractive index 1.51) 20 parts by weight

Colloidal silica dispersed in MEK (particle diameter 10 to 20 nm, solid matter 30%) 20 parts by weight

### (Photo-Curable Initiator)

Irgacure 184 (manufactured by Ciba Specialty Chemicals Inc.) 1.2 parts by weight

Irgacure 907 (manufactured by Ciba Specialty Chemicals Inc.) 0.2 parts by weight

### (Fine Particles)

Mono-dispersed styrene beads (particle diameter 3.5 μm, refractive index 1.60) 1.9 parts by weight

### (Leveling Agent)

Silicone leveling agent 10-28 (manufactured Dainichiseika Color & Chemicals Mfg. Co., Ltd.) 0.09 parts by weight

A solvent containing toluene:cyclohexane at 8:2 was added to the above-mentioned materials so as to adjust the total solid matter content of 40% and the mixture was sufficiently mixed to produce a composition. The composition was filtered by a polypropylene filter with pore diameter of 30 μm to produce a composition 11 for a hard coat layer (B).

### Composition 12 for Hard Coat Layer (B)

### (Ultraviolet Ray Curable Resin)

Polyfunctional urethane acrylate HDP (manufactured by Negami Chemical Industrial Co., Ltd., deca-functional, molecular weight 4500, refractive index 1.51) 10 parts by weight

Pentaerythritol triacrylate (PETA) (refractive index 1.51) 10 parts by weight

Cellulose acetate propionate (molecular weight 50000) 0.4 parts by weight

### (Photo-Curable Initiator)

Irgacure 184 (manufactured by Ciba Specialty Chemicals Inc.) 1.2 parts by weight

Irgacure 907 (manufactured by Ciba Specialty Chemicals Inc.) 0.2 parts by weight

### (Fine Particles)

Nonspherical silica (average particle diameter 1.5 μm, subjected to hydrophobic surface treatment with a silane coupling agent) 0.88 parts by weight

### (Leveling Agent)

Silicone leveling agent 0.012 parts by weight

### (Solvent)

Toluene 35 parts by weight

Methyl isobutyl ketone 6.7 parts by weight

The above-mentioned materials were sufficiently mixed to obtain a composition. The composition was filtered by a polypropylene filter with pore diameter of 30 μm to produce a composition 12 for a hard coat layer (B) with a solid matter content of 35% by weight.

### Composition 13 for Hard Coat Layer (B)

### (Thermosetting Resin)

Polyester resin Vylon 200 (manufactured by Toyobo Co., Ltd., refractive index 1.55) 100 parts by weight

### (Curing Agent)

Isocyanate XEL curing agent (manufactured by Inctec Inc.) 2.7 parts by weight

### (Fine Particles)

Acrylic beads (manufactured by Sekisui Plastics Co., Ltd., MBX-8, average particle diameter 8 μm, refractive index 1.49) 180 parts by weight

### (Solvent)

Toluene 130 parts by weight

Methyl ethyl ketone 100 parts by weight

The above-mentioned materials were sufficiently mixed to obtain a composition. The composition was filtered by a polypropylene filter with pore diameter of 30 μm to produce a composition 13 for a hard coat layer (B) with a solid matter content of 50% by weight.

### Composition 14 for Hard Coat Layer (B)

### (Thermosetting Resin)

Polyester resin Vylon 200 (manufactured by Toyobo Co., Ltd., refractive index 1.55) 100 parts by weight

### (Curing Agent)

Isocyanate XEL curing agent (manufactured by Inctec Inc.) 2.7 parts by weight

### (Fine Particles)

Acrylic beads (manufactured by Sekisui Plastics Co., Ltd., MBX-5, average particle diameter 5 μm, refractive index 1.49) 120 parts by weight

### (Solvent)

Toluene 130 parts by weight

Methyl ethyl ketone 100 parts by weight

The above-mentioned materials were sufficiently mixed to obtain a composition. The composition was filtered by a polypropylene filter with pore diameter of 30 μm to produce a composition 14 for a hard coat layer (B) with a solid matter content of 50% by weight.

### Composition for Surface Adjustment Layer

### Composition for Surface Adjustment Layer 1

### (Ultraviolet Ray Curable Resin)

UV 1700B (manufactured by Nippon Synthetic Chemical Industry., Co., Ltd., refractive index 1.51) 31.1 parts by weight

Aronix M 315 (trade name, manufactured by Toagosei Chemical Industry Co., Ltd., isocyanuric acid ethylene oxide (3 mol) adduct triacrylate) 10.4 parts by weight

### (Photo-Curable Initiator)

Irgacure 184 (manufactured by Ciba Specialty Chemicals Inc.) 1.49 parts by weight

Irgacure 907 (manufactured by Ciba Specialty Chemicals Inc.) 0.41 parts by weight

### (Antifouling Agent)

UT-3971 (manufactured by The Nippon Synthetic Chemical Industry., Co., Ltd.,) 2.07 parts by weight

### (Solvent)

Toluene 525.18 parts by weight

Cyclohexanone 60.28 parts by weight

The above-mentioned materials were sufficiently mixed to obtain a composition. The composition was filtered by a polypropylene filter with pore diameter of 10 μm to produce a composition 1 for a surface adjustment layer with a solid matter content of 40.5% by weight.

### Composition for Surface Adjustment Layer 2 (P/V=30/10)

Colloidal silica slurry (MIBK dispersion; solid matter 40%, average particle diameter 20 nm) 2.91 parts by weight

UV 1700B (manufactured by Nippon Synthetic Chemical Industry., Co., Ltd., solid matter 60% MIBK) 6.10 parts by weight

Aronix M 215 (ultraviolet-curable resin, manufactured by Toagosei Chemical Industry Co., Ltd., isocyanuric acid ethylene oxide (2 mol) adduct diacrylate, solid matter 60% MIBK) 1.52 parts by weight

### (Photo-Curable Initiator)

Irgacure 184 (manufactured by Ciba Specialty Chemicals Inc.) 0.018 parts by weight

Irgacure 907 (manufactured by Ciba Specialty Chemicals Inc.) 0.003 parts by weight

### (Leveling Agent)

Silicone leveling agent 10-28 (manufactured by Dainichiseika Color & Chemicals Mfg. Co., Ltd.) 0.0085 parts by weight

### (Solvent)

MIBK: methyl isobutyl ketone 2.06 parts by weight

Cyclohexanone 0.41 parts by weight

The above-mentioned materials were sufficiently mixed to obtain a composition. The composition was filtered by a polypropylene filter with pore diameter of 30 μm to produce a composition 2 for a surface adjustment layer with a solid matter content of about 45% by weight.

### Composition for Low Refractive Index Layer

Hollow silica slurry (IPA, MIBK dispersion, solid matter 20%, particle diameter 50 nm) 9.57 parts by weight

Pentaerythritol triacrylate PET 30 (Ultraviolet ray curable resin, manufactured by Nippon Kayaku Co., Ltd.) 0.981 parts by weight

AR 110 (fluoropolymer; Solid matter 15% MIBK solution; manufactured by Daikin Industries, Ltd.) 6.53 parts by weight

Irgacure 184 (photo-curable initiator: manufactured by Ciba Specialty Chemicals Inc.) 0.069 parts by weight

Silicone leveling agent 0.157 parts by weight

Propylene glycol monomethyl ether (PGME) 28.8 parts by weight

Methyl isobutyl ketone 53.9 parts by weight

After the above-mentioned materials were stirred, the mixture was filtered by a polypropylene filter with pore diameter of 10 μm to produce a composition for a low refractive index layer with a solid matter content of 4% by weight. This composition has a refractive index of 1.40.

### Example 1

### Formation of Clear Hard Coat Layer (A)

The composition 1 for the clear hard coat layer (A) was applied in a thickness of about 12 μm on one surface of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 1 for the hard coat layer (B) was applied by using a wire wound rod for coating (Mayer bar (metering coating rod)) #10 on the clear hard coat layer (A) and heat-dried at 70° C. for 1 minute in an oven to evaporate the solvent component, and then curing a coat by radiating ultraviolet rays in a radiation dose of 30 mJ to form the hard coat layer (B).

### Formation of Surface Adjustment Layer

Further, the composition 1 for the surface adjustment layer was applied by using a wire wound rod for coating (Mayer bar (metering coating rod)) #6 on the hard coat layer (B) and heat-dried at 70° C. for 1 minute in an oven to evaporate the solvent component, and then curing a coat by radiating ultraviolet rays in a radiation dose of 100 mJ under nitrogen purge (oxygen concentration 200 ppm or lower) to form the surface adjustment layer and obtain an antiglare optical layered body. (total thickness of the layered body on the substrate: about 19 μm)

### Example 2

### Formation of Clear Hard Coat Layer (A)

The composition 2 for the clear hard coat layer (A) was applied in a thickness of about 6 μm on one surface of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 2 for the hard coat layer (B) was applied by using a wire wound rod for coating (Mayer bar (metering coating rod)) #14 on the clear hard coat layer (A) and heat-dried at 70° C. for 1 minute in an oven to evaporate the solvent component, and curing a coat by radiating ultraviolet rays in a radiation dose of 30 mJ to form the hard coat layer (B).

### Formation of Surface Adjustment Layer

Further, the composition 1 for the surface adjustment layer was applied using a wire wound rod for coating (Mayer bar (metering coating rod)) #14 on the hard coat layer (B) and heat-dried at 70° C. for 1 minute in an oven to evaporate the solvent component, and curing a coat by radiating ultraviolet rays in a radiation dose of 100 mJ under nitrogen purge (oxygen concentration 200 ppm or lower) to form the surface adjustment layer and obtain an antiglare optical layered body. (total thickness of the layered body on the substrate: about 22.5 μm)

### Example 3

### Formation of Clear Hard Coat Layer (A)

The composition 3 for the clear hard coat layer (A) was applied in a thickness of about 12 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 3 for the hard coat layer (B) was applied using a wire wound rod for coating (Mayer bar (metering coating rod)) #24 on the clear hard coat layer (A) and heat-dried at 70° C. for 1 minute in an oven to evaporate the solvent component, and under nitrogen purge (oxygen concentration 200 ppm or lower), curing a coat by radiating ultraviolet rays in a radiation dose of 100 mJ to form the hard coat layer (B) and thus obtain an antiglare optical layered body. (total thickness of the layered body on the substrate: about 25 μm)

### Example 4

### Formation of Clear Hard Coat Layer (A)

The composition 3 for the clear hard coat layer (A) was applied in a thickness of about 12 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 3 for the hard coat layer (B) was applied using a wire wound rod for coating (Mayer bar (metering coating rod)) #24 on the clear hard coat layer (A) and heat-dried at 70° C. for 1 minute in an oven to evaporate the solvent component, and curing a coat by radiating ultraviolet rays in a radiation dose of 40 mJ to form the hard coat layer (B).

### Formation of Low Refractive Index Layer

Further, the composition for the low refractive index layer was applied using a wire wound rod for coating (Mayer bar (metering coating rod)) #2 on the hard coat layer (B) and heat-dried at 70° C. for 1 minute in an oven to evaporate the solvent component, and curing a coating by radiating ultraviolet rays in a radiation dose of 100 mJ under nitrogen purge (oxygen concentration 200 ppm or lower) to form the low refractive index layer and obtain an antiglare optical layered body. (total thickness of the layered body on the substrate: about 25 μm)

### Example 5

### Formation of Clear Hard Coat Layer (A)

The composition 1 for the clear hard coat layer (A) was applied in a thickness of about 12 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 4 for the hard coat layer (B) was applied using a wire wound rod for coating (Mayer bar (metering coating rod)) #14 on the clear hard coat layer (A) and heat-dried at 70° C. for 1 minute in an oven to evaporate the solvent component, and curing a coat by radiating ultraviolet rays in a radiation dose of 30 mJ to form the hard coat layer (B).

### Formation of Surface Adjustment Layer

Further, the composition 2 for the surface adjustment layer was applied using a wire wound rod for coating (Mayer bar (metering coating rod)) #10 on the hard coat layer (B) and heat-dried at 70° C. for 1 minute in an oven to evaporate the solvent component, and curing a coat by radiating ultraviolet rays in a radiation dose of 100 mJ under nitrogen purge (oxygen concentration 200 ppm or lower) to form the surface adjustment layer and obtain an antiglare optical layered body. (total thickness of the layered body on the substrate: about 24 μm)

### Example 6

### Formation of Clear Hard Coat Layer (A)

The composition 2 for the clear hard coat layer (A) was applied in a thickness of about 12 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 5 for the hard coat layer (B) was applied using a wire wound rod for coating (Mayer bar (metering coating rod)) #6 on the clear hard coat layer (A) and heat-dried at 70° C. for 1 minute in an oven to evaporate the solvent component, and under nitrogen purge (oxygen concentration 200 ppm or lower), curing a coat by radiating ultraviolet rays in a radiation dose of 100 mJ to form the hard coat layer (B) and thus obtain an antiglare optical layered body.

(total thickness of the layered body on the substrate: about 15 μm)

### Example 7

### Formation of Clear Hard Coat Layer (A)

The composition 3 for the clear hard coat layer (A) was applied in a thickness of about 10 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 6 for the hard coat layer (B) was applied using a wire wound rod for coating (Mayer bar (metering coating rod)) #10 on the clear hard coat layer (A) and heat-dried at 70° C. for 1 minute in an oven to evaporate the solvent component, and under nitrogen purge (oxygen concentration 200 ppm or lower), curing a coating by radiating ultraviolet rays in a radiation dose of 100 mJ to form the hard coat layer (B) and thus obtain an antiglare optical layered body. (total thickness of the layered body on the substrate: about 16 μm)

### Example 8

### Formation of Clear Hard Coat Layer (A)

The composition 2 for the clear hard coat layer (A) was applied in a thickness of about 10 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 7 for the hard coat layer (B) was applied using a wire wound rod for coating (Mayer bar (metering coating rod)) #24 on the clear hard coat layer (A) and heat-dried at 70° C. for 1 minute in an oven to evaporate the solvent component, and under nitrogen purge (oxygen concentration 200 ppm or lower), curing a coat by radiating ultraviolet rays in a radiation dose of 100 mJ to form the hard coat layer (B) and thus obtain an antiglare optical layered body. (total thickness of the layered body on the substrate: about 18 μm)

### Example 9

### Formation of Primer Layer

A modified polyolefin primer (Unistole P 901, manufactured by Mitsui Chemicals Inc.) was applied in a thickness of 3 μm to an Arton film (thickness 100 μm, manufactured by JSR Co., Ltd.) to form a primer layer.

### Formation of Clear Hard Coat Layer (A)

Further, the composition 1 for the clear hard coat layer (A) was applied in a thickness of about 10 μm to the primer layer. The clear hard coat layer (A) for undercoat was formed by drying at 70° C. for 60 seconds and radiating 40 mJ/cm² of ultraviolet.

### Formation of Hard Coat Layer (B)

Further, the composition 8 for the hard coat layer (B) was applied using a wire wound rod for coating (Mayer bar (metering coating rod)) #6 on the clear hard coat layer (A) and heat-dried at 70° C. for 1 minute in an oven to evaporate the solvent component, and under nitrogen purge (oxygen concentration 200 ppm or lower), curing a coat by radiating ultraviolet rays in a radiation dose of 100 mJ to form the hard coat layer (B) and thus obtain an antiglare optical layered body. (total thickness of the layered body on the substrate: about 16 μm)

### Example 10

### Formation of Clear Hard Coat Layer (A)

The composition 3 for the clear hard coat layer (A) was applied in a thickness of about 5 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 9 for the hard coat layer (B) was applied using a wire wound rod for coating (Mayer bar (metering coating rod)) #34 on the clear hard coat layer (A) and heat-dried at 70° C. for 1 minute in an oven to evaporate the solvent component, and under nitrogen purge (oxygen concentration 200 ppm or lower), curing a coat by radiating ultraviolet rays in a radiation dose of 100 mJ to form the hard coat layer (B) and thus obtain an antiglare optical layered body. (total thickness of the layered body on the substrate: about 25 μm)

### Example 11

### Formation of Clear Hard Coat Layer (A)

The composition 1 for the clear hard coat layer (A) was applied in a thickness of about 5 μm to one face of a cellulose triacetate film (thickness 80 μm). The clear hard coat layer (A) for undercoat was formed by drying at 70° C. for 60 seconds and radiating 40 mJ/cm² of ultraviolet.

### Production of Emboss Roller

A roller made of iron was made available and beads shot was carried out for the surface of the roller using glass beads of 100 mesh (particle diameter distribution; 106 μm to 150 μm) to form peaks and valleys and the obtained rough face was plated with chromium in a thickness of 5 μm to obtain an emboss roller. At the time of beads shot, the blowing pressure and the interval between a spraying nozzle and the roller were adjusted to produce the emboss roller matched with the optical characteristics of the surface roughness of the antiglare layer of the optical layered body of the present invention.

### Formation of Primer Layer

Using a composition obtained by mixing a polyurethane resin type primer coating composition (manufactured by Inctec Inc., medium main agent for chemical mat varnish, curing agent: XEL curing agent (D) at a weight ratio of main agent/curing agent/solvent of 10/1/3.3, gravure coating was carried out for the hard coat layer A and the coating was dried to form a primer layer with a thickness of 3 Toluene/methyl ethyl ketone=1/1 was used as the solvent.

### Formation of Hard Coat Layer (B)

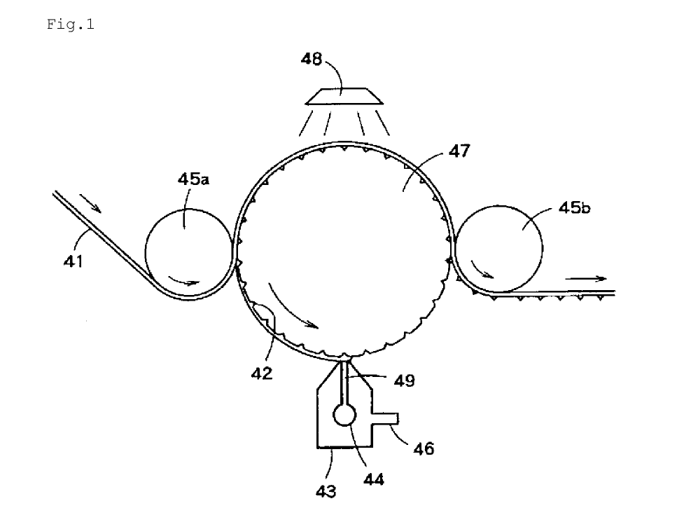

The emboss roller was installed in the production apparatus (emboss apparatus 40) shown in FIG. 1 and the produced composition 10 for the hard coat layer (B) was supplied to a liquid storage of a coating head. The liquid storage was constantly kept at 40° C. The substrate having the clear hard coat layer (A) and the primer layer was supplied to the emboss roll. The composition 10 for the hard coat layer (B) was applied to the emboss roller and the substrate was overlapped on the composition and formed using a rubber roller and successively ultraviolet ray in an intensity of 200 mJ was radiated from the film side using an ultraviolet light source for curing and the coating was separated from the emboss roller to form an antiglare optical layered body. (total thickness of the layered body on the substrate: about 20 μm)

### Example 12

### Formation of Clear Hard Coat Layer (A)

The composition 2 for the clear hard coat layer (A) was applied in a thickness of about 12 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 11 for the hard coat layer (B) was applied using a wire wound rod for coating (Mayer bar (metering coating rod)) #12 on the clear hard coat layer (A) and heat-dried at 70° C. for 1 minute in an oven to evaporate the solvent component, and under nitrogen purge (oxygen concentration 200 ppm or lower), curing a coat by radiating ultraviolet rays in a radiation dose of 100 mJ to form the hard coat layer (B) and thus obtain an antiglare optical layered body. (total thickness of the layered body on the substrate: about 18 μm)

### Example 13

### Formation of Clear Hard Coat Layer (A)

The composition 1 for the clear hard coat layer (A) was applied in a thickness of about 12 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 12 for the hard coat layer (B) was applied with a wire wound rod for coating (Mayer bar (metering coating rod)) #6 on the clear hard coat layer (A) and heat-dried at 70° C. for 1 minute in an oven to evaporate the solvent component, and under nitrogen purge (oxygen concentration 200 ppm or lower), curing a coating by radiating ultraviolet rays in a radiation dose of 100 mJ to form the hard coat layer (B) and thus obtain an antiglare optical layered body. (total thickness of the layered body on the substrate: about 15 μm)

### Comparative Example 1

### Formation of Clear Hard Coat Layer (A)

The composition 4 for the clear hard coat layer (A) was applied in a thickness of about 6 μm to one face of a cellulose triacetate film (thickness 80 μm). The clear hard coat layer (A) for undercoat was formed by drying at 70° C. for 60 seconds and radiating 40 mJ/cm² of ultraviolet.

### Formation of Hard Coat Layer (B)

Further, the composition 13 for the hard coat layer (B) was applied with a wire wound rod for coating (Mayer bar (metering coating rod)) #24 on the clear hard coat layer (A) and heat-dried at 80° C. for 2 minutes in an oven to evaporate the solvent component, and thermally curing a coat to form the hard coat layer (B) and thus obtain an antiglare optical layered body. (total thickness of the layered body on the substrate: about 24 μm)

### Comparative Example 2

### Formation of Hard Coat Layer (B)

The composition 14 for the hard coat layer (B) was applied to one face of a cellulose triacetate film (thickness 80 μm) using a wire wound rod for coating (Mayer bar (metering coating rod)) #28 and heat-dried at 80° C. for 2 minutes in an oven to evaporate the solvent component, and thereafter, the formed coat was thermally cured to form the hard coat layer (B) and thus obtain an antiglare optical layered body. (total thickness of the layered body on the substrate: about 20 μm)

With respect to the optical layered bodies, φ, θa, Rz, and Sm were measured. The reference length was 0.8 mm. Further, the evaluation was carried out based on the following evaluation methods. The results are shown in Table 1.

### (1) Interference Fringe Formation Test

A black tape for preventing back face reflection was stuck to the opposed face of the hard coat layer of each optical layered body and the optical layered body was observed from the hard coat layer side with eyes under lighting with a 30 W three-wavelength lamp and evaluated according to the following evaluation standard.

### Evaluation Standard

Evaluation good: no interference fringe generated
Evaluation poor: interference fringes generated

### (2) Pencil Hardness Test

After humidity of each of the produced optical layered bodies was adjusted at a temperature of 25° C. and relative humidity of 60% for 2 hours, the test was carried out at a load of 4.9 N according to the pencil hardness evaluation test standardized in JIS-K-5400 using a pencil (hardness 4H) for test standardized in JIS-S-6006.

### Evaluation Standard

Evaluation good: no scratch/measurement times=4/5, 5/5
Evaluation poor: no scratch/measurement times=0/5, 1/5, 2/5, 3/5

TABLE 1

| | Sm | Rz | θa | | Interference | Pencil |
|---|---|---|---|---|---|---|
| | (μm) | (μm) | (°) | φ | fringes | hardness |
| Example 1 | 136.2 | 0.51 | 0.402 | 0.0037 | Good | Good |
| 2 | 142.5 | 0.402 | 0.312 | 0.0028 | Good | Good |
| 3 | 166.8 | 0.812 | 0.79 | 0.0049 | Good | Good |
| 4 | 181.9 | 0.632 | 0.426 | 0.0035 | Good | Good |
| 5 | 106.7 | 0.464 | 0.423 | 0.0043 | Good | Good |
| 6 | 62.5 | 4.61 | 3.103 | 0.0738 | Good | Good |
| 7 | 341 | 1.105 | 1.003 | 0.0032 | Good | Good |
| 8 | 71 | 0.81 | 1.1 | 0.0114 | Good | Good |
| 9 | 58.8 | 2.045 | 2.093 | 0.0348 | Good | Good |
| 10 | 55.3 | 0.514 | 0.733 | 0.0093 | Good | Good |
| 11 | 86.7 | 0.696 | 0.864 | 0.0080 | Good | Good |
| 12 | 107.5 | 0.658 | 0.833 | 0.0061 | Good | Good |
| 13 | 47.6 | 3.47 | 4.471 | 0.0729 | Good | Good |
| Comparative | 53.5 | 8.13 | 6.805 | 0.1520 | Poor | Poor |
| Example 1 | | | | | | |
| 2 | 77.8 | 5.682 | 6.214 | 0.0730 | Poor | Poor |

It was confirmed that an optical layered body of the present invention had good pencil hardness and showed no interference fringe.

### INDUSTRIAL APPLICABILITY

The optical layered body of the present invention can be used as an antireflection film for a cathode-ray tube display device (CRT), a liquid crystal display (LCD), a plasma display (PDP), an electroluminescence display (ELD), and the like.

1. An optical layered body, comprising
a light-transmitting substrate and a hard coat layer formed on the light-transmitting substrate,
wherein the hard coat layer comprises two layers of a clear hard coat layer (A) and a hard coat layer (B),
the hard coat layer (B) has a surface roughness on the outermost surface and satisfies
0.0010≦φ≦0.14
0.25≦θa≦5.0
in the case where Sm is defined as a mean spacing of profile irregularities; θa is defined as a mean inclination angle of profile irregularities; Rz is defined as a mean roughness of the surface roughness; and φ is defined as Rz/Sm, and
the optical layered body has substantially no interface between the clear hard coat layer (A) and the light-transmitting substrate.

2. The optical layered body according to claim 1,
wherein Rz is 0.3 to 5.0 μm;
Sm is 40 to 400 μm; and
0.0020≦φ≦0.080.

3. The optical layered body according to claim 1,
wherein the hard coat layer (B) is formed from a composition (B) containing an urethane (meth)acrylate compound having six or more functional groups.

4. The optical layered body according to claim 3,
wherein the urethane (meth)acrylate compound has a weight average molecular weight of 1000 to 50000.

5. The optical layered body according to claim 1, which has substantially no interference fringe.

6. The optical layered body according to claim 1,
wherein the clear hard coat layer (A) is formed using a compound (A) having a weight average molecular weight of 200 or more and three or more functional groups.

7. The optical layered body according to claim 6,
wherein the compound (A) is at least one kind compound of (meth)acrylic compounds and/or urethane (meth)acrylic compounds.

8. The optical layered body according to claim 1,
which is an antireflection layered body.

9. The optical layered body according to claim 1,
which has the surface haze value of 0.5 to 30 or lower.

10. The optical layered body according to claim 1,
which has 4H or higher under the condition of 4.9 N load in a pencil hardness test according to JIS K5400.

11. A method for producing the optical layered body according to claim 1,
comprising steps for forming a clear hard coat layer (A) by applying a composition for the clear hard coat layer (A) to the surface of a light-transmitting substrate produced from a triacetyl cellulose as a raw material and
forming a hard coat layer (B) by applying a composition for the hard coat layer (B) to the clear hard coat layer (A).

12. A self-luminous image display device comprising the optical layered body according to claim 1 on the outermost surface.

13. A polarizer comprising a polarizing element,
wherein the surface of the polarizing element has the optical layered body according to claim 1 on the face opposite to a face where the hard coat layer of the optical layered body is present.

14. A non-self-luminous image display device comprising the optical layered body according to claim 1.

15. A non-self-luminous image display device comprising the polarizer according to claim 13 on the outermost surface.

16. The optical layered body according to claim 2,
wherein the hard coat layer (B) is formed from a composition (B) containing an urethane (meth)acrylate compound having six or more functional groups.

17. The optical layered body according to claim 2, which has substantially no interference fringe.

18. The optical layered body according to claim 3, which has substantially no interference fringe.

19. The optical layered body according to claim 4, which has substantially no interference fringe.

20. The optical layered body according to claim 2,
wherein the clear hard coat layer (A) is formed using a compound (A) having a weight average molecular weight of 200 or more and three or more functional groups.
